(19) United States
(12) Patent Application Publication
(10) Pub. No.: US 2024/0211006 A1
(43) Pub. Date: Jun. 27, 2024

(54) ELECTRONIC DEVICES WITH MMWAVE ANTENNAS

(71) Applicants: Jayprakash Thakur, BANGALORE (IN); Richard S. Perry, Portland, OR (US); Madhukiran Srinivasareddy, Bangalore (IN); Tejasweeni D. Lingayat, Dapoli (IN); Maruti Tamrakar, Chennai (IN); Arjun Chandrashekar, Bengaluru (IN); Vamshi krishna Aagiru, Bangalore (IN); Rekha Bhagat, Cuttack (IN); Nithesha A, Surathkal (IN); Karthi Kaliswamy, Bangalore (IN); Sagar Gupta, Ghaziabad (IN); Zaman Zaid Mulla, Mumbai (IN); Jay Vishnu Gupta, Bengaluru (IN); Prathibha Peddireddy, Bengaluru (IN); Ravi Kumar, BENGALURU (IN); Megha Kolkebail Vijaya, Bangalore (IN); A Ezekiel Poulose, Kerala (IN)

(72) Inventors: Jayprakash Thakur, BANGALORE (IN); Richard S. Perry, Portland, OR (US); Madhukiran Srinivasareddy, Bangalore (IN); Tejasweeni D. Lingayat, Dapoli (IN); Maruti Tamrakar, Chennai (IN); Arjun Chandrashekar, Bengaluru (IN); Vamshi krishna Aagiru, Bangalore (IN); Rekha Bhagat, Cuttack (IN); Nithesha A, Surathkal (IN); Karthi Kaliswamy, Bangalore (IN); Sagar Gupta, Ghaziabad (IN); Zaman Zaid Mulla, Mumbai (IN); Jay Vishnu Gupta, Bengaluru (IN); Prathibha Peddireddy, Bengaluru (IN); Ravi Kumar, BENGALURU (IN); Megha Kolkebail Vijaya, Bangalore (IN); A Ezekiel Poulose, Kerala (IN)

(21) Appl. No.: 18/086,405

(22) Filed: Dec. 21, 2022

(51) Int. Cl. G06F 1/16; H01Q 1/22; H01Q 1/52; H01Q 3/06; H04B 1/40

(52) U.S. Cl. CPC G06F 1/1698; G06F 1/1681; H01Q 1/2266; H01Q 1/526; H01Q 3/06; H04B 1/40

(57) ABSTRACT

Antennas and electronic devices using antennas are described herein. A mmWave antenna integrated module (AiM) may be disposed in a barrel hinge between the display and base portions of a laptop. An AiM module on the chassis of the laptop uses base station location and laptop location and orientation to rotate to provide mmWave communication. The chassis-mounted AiM module may be able to be magnetically attached and make electrical connection via pogo pins. A flexible printed circuit (FPC) and metal box may surround the AiM module to form an electromagnetic interference shield and thermal spreader. An identification system may be used to determine whether an antenna is compatible with a modem of the electronic device based on analog or digital signaling between the antenna side and modem side. An FPC may be disposed between portions of a bisected speaker box.

### TECHNICAL FIELD

Embodiments pertain to mmWave antennas in electronic devices. In particular, some embodiments relate to mmWave antenna integrated module (AiM) modules incorporated in electronic devices.

### BACKGROUND

The use and complexity of wireless systems has increased due to both an increase in the types of electronic devices using network resources as well as the amount of data and bandwidth being used by various applications, such as video streaming, operating on the electronic devices. As expected, a number of issues abound with the advent of any new technology, including complexities related to the integration of mmWave communications (i.e., communications in the mm wave bands) in electronic devices.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1 is a block diagram of a radio architecture in accordance with some embodiments.

FIG. 2 illustrates a front-end module circuitry for use in the radio architecture of FIG. 1 in accordance with some embodiments.

FIG. 3 illustrates a radio IC circuitry for use in the radio architecture of FIG. 1 in accordance with some embodiments.

FIG. 4 illustrates a baseband processing circuitry for use in the radio architecture of FIG. 1 in accordance with some embodiments.

FIG. 5 illustrates a WLAN in accordance with some embodiments.

FIG. 6 illustrates a block diagram of a communication device in accordance with some embodiments.

FIG. 7A illustrates radiation axes for a laptop in accordance with some embodiments.

FIG. 7B illustrates radiation for a closed lid laptop with a top firing AiM module in accordance with some embodiments.

FIG. 7C illustrates radiation for an open lid laptop with a top firing AiM module in accordance with some embodiments.

FIG. 7D illustrates radiation for a closed lid laptop with a 60° firing AiM module in accordance with some embodiments.

FIG. 7E illustrates radiation for an open lid laptop with a 60° firing AiM module in accordance with some embodiments.

FIG. 7F illustrates radiation for a closed lid laptop with a 110° firing AiM module in accordance with some embodiments.

FIG. 7G illustrates radiation for an open lid laptop with a 110° firing AiM module in accordance with some embodiments.

FIG. 8A illustrates a modular hinge antenna holder in accordance with some embodiments.

FIG. 8B illustrates another view of the modular hinge antenna holder of FIG. 8A in accordance with some embodiments.

FIG. 8C illustrates another view of the modular hinge antenna holder of FIG. 8A in accordance with some embodiments.

FIG. 8D illustrates an exploded view of the modular hinge antenna holder of FIG. 8A in accordance with some embodiments.

FIG. 9A illustrates an arrangement for preventing vibration to AiM module in accordance with some embodiments.

FIG. 9B illustrates another view of the arrangement of FIG. 9A in accordance with some embodiments.

FIG. 10 illustrates cable routing to enable placement in a barrel hinge in accordance with some embodiments.

FIG. 11A illustrates cable clamps for fixing cable movement in accordance with some embodiments.

FIG. 11B illustrates another view of the cable clamps of FIG. 11A in accordance with some embodiments.

FIG. 12A illustrates cable splitting for a mmWave AiM module near hinge in accordance with some embodiments.

FIG. 12B illustrates another view of the cable splitting of FIG. 12A in accordance with some embodiments.

FIG. 13A illustrates a modular hinge mechanism in accordance with some embodiments.

FIG. 13B illustrates another view of the modular hinge mechanism of FIG. 13A in accordance with some embodiments.

FIG. 13C illustrates another view of the modular hinge mechanism of FIG. 13A in accordance with some embodiments.

FIG. 14 illustrates a closed lid view for a static barrel hinge in accordance with some embodiments.

FIG. 15A illustrates radiation for a closed lid laptop with a 110° firing AiM module with a static hinge in accordance with some embodiments.

FIG. 15B illustrates radiation for an open lid laptop with a 110° firing AiM module with a static hinge in accordance with some embodiments.

FIG. 16 illustrates an AiM module in accordance with some embodiments.

FIG. 17 illustrates a laptop with multiple AiM modules in accordance with some embodiments.

FIG. 18 illustrates equivalent isotropic radiated power (EIRP) of a laptop with multiple AiM modules in accordance with some embodiments.

FIG. 19 illustrates a rotatable AiM module in accordance with some embodiments.

FIG. 20 illustrates a system with a laptop with a rotatable AiM module in accordance with some embodiments.

FIG. 21 illustrates communications in a system with a laptop with a rotatable AiM module in accordance with some embodiments.

FIG. 22 illustrates a flowchart of use of a rotatable AiM module in accordance with some embodiments.

FIG. 23 illustrates a block diagram of an AiM module in accordance with some embodiments.

FIG. 24 illustrates AiM modules inside a dongle in accordance with some embodiments.

FIG. 25 illustrates a dongle on laptop covers in accordance with some embodiments.

FIG. 26A illustrates a dongle placement on a laptop cover in accordance with some embodiments.

FIG. 26B illustrates a dongle placement on a laptop base in accordance with some embodiments.

FIG. 27 illustrates AiM module radiation coverage in accordance with some embodiments.

FIG. 28A illustrates a view of a connector in accordance with some embodiments.

FIG. 28B illustrates another view of the connector of FIG. 28A in accordance with some embodiments.

FIG. 29A illustrates a top view of a radio frequency (RF) connector in accordance with some embodiments.

FIG. 29B illustrates a cutaway view of the RF connector of FIG. 29A in accordance with some embodiments.

FIG. 30 illustrates an antenna module dongle in accordance with some embodiments.

FIG. 31A illustrates a front view of an AiM module in accordance with some embodiments.

FIG. 31B illustrates a back view of the AiM module of FIG. 31A in accordance with some embodiments.

FIG. 31C illustrates a portion of the back view of FIG. 31B in accordance with some embodiments.

FIG. 31D illustrates an exploded view of the AiM module of FIG. 31A in accordance with some embodiments.

FIG. 31E illustrates an electromagnetic interference (EMI) shield assembly in accordance with some embodiments.

FIG. 32 illustrates feedback circuitry in accordance with some embodiments.

FIG. 33A illustrates a C-cover containing merging horizontal slots in accordance with some embodiments.

FIG. 33A illustrates a perspective view of a C-cover containing merging horizontal slots in accordance with some embodiments.

FIG. 33B illustrates an enlarged portion of the C-cover of FIG. 33A in accordance with some embodiments.

FIG. 33C illustrates a side view of the C-cover of FIG. 33A in accordance with some embodiments.

FIG. 33D illustrates a side view of a D-cover associated with the C-cover of FIG. 33A in accordance with some embodiments.

FIG. 33E illustrates an enlarged view of an FPC shown in FIG. 33C in accordance with some embodiments.

FIG. 33F illustrates another view of the side view of the C-cover of FIG. 33A in accordance with some embodiments.

FIG. 34 illustrates S-parameter results of combined horizontal slot in accordance with some embodiments.

FIG. 35A illustrates merging vertical slots in accordance with some embodiments.

FIG. 35B illustrates C-cover metal containing the merging vertical slots of FIG. 35A in accordance with some embodiments.

FIG. 35C illustrates D-cover metal containing the merging vertical slots of FIG. 35A in accordance with some embodiments.

FIG. 36 illustrates S-parameter results of combined vertical slots with a half wavelength stub in accordance with some embodiments.

FIG. 37 illustrates a split speaker-integrated antenna in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

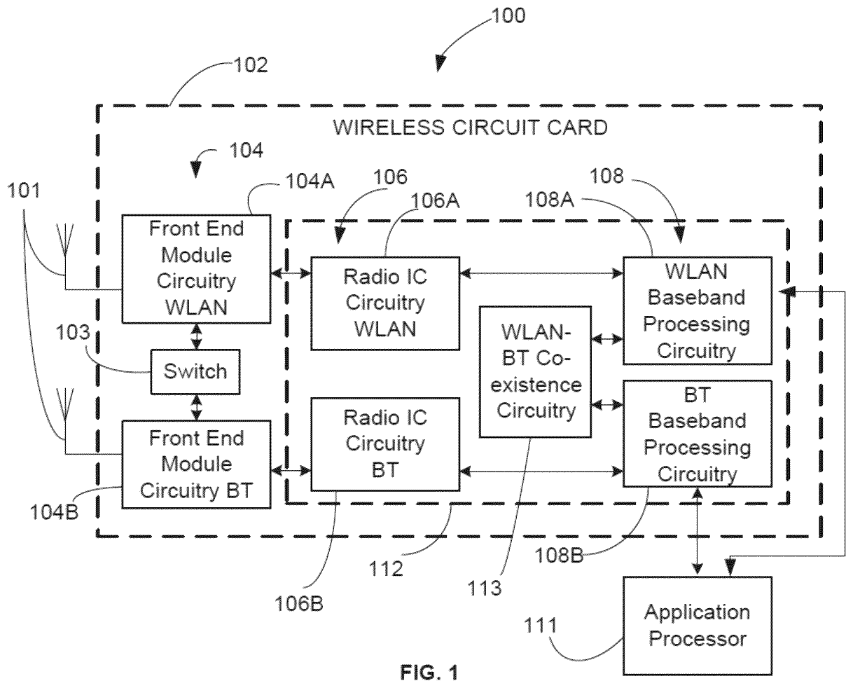

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM 104A and FEM 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband circuitry 108A and a BT baseband processing circuitry 108B. The WLAN baseband circuitry 108A may include a memory, such as, for example, a set of RAM arrays in a Fast Fourier Transform or Inverse Fast Fourier Transform block (not shown) of the WLAN baseband circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the WLAN baseband circuitry 108A and the BT baseband circuitry 108B may further include physical layer (PHY) and medium access control layer (MAC) circuitry, and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM 104A or 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or IC, such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, and/or IEEE 802.11ax standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards

In some embodiments, the radio architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHZ, 2.4 GHz, 5 GHz, and bandwidths of about 1 MHz, 2 MHZ, 2.5 MHz, 4 MHZ, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

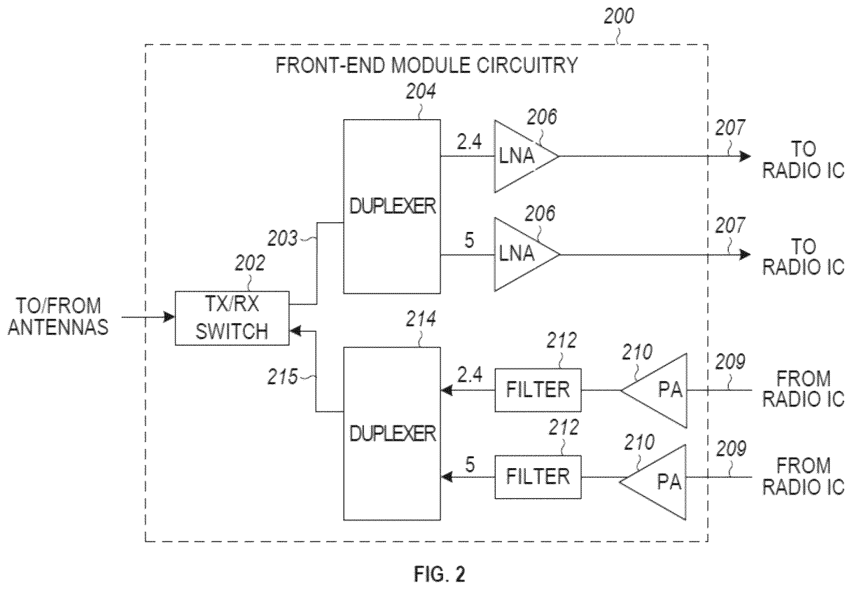

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

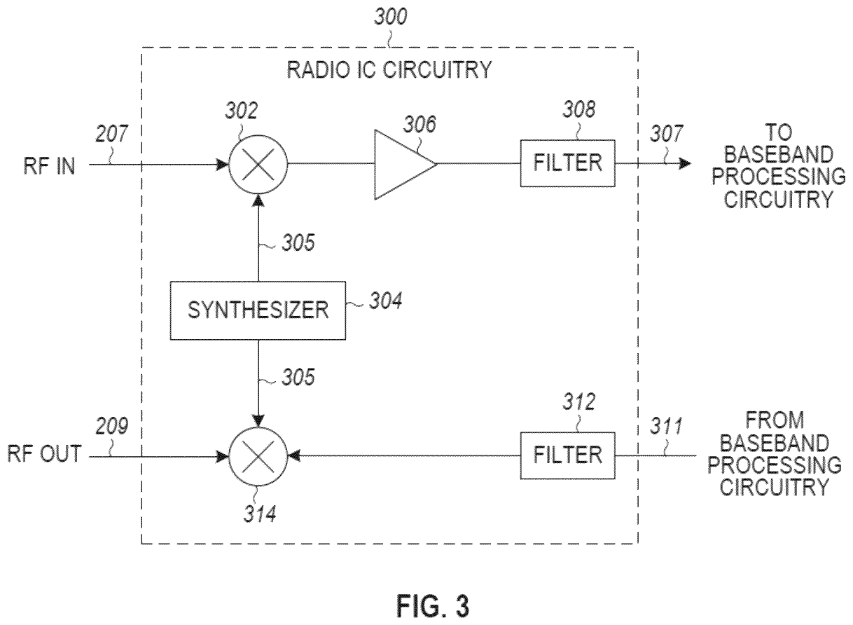

FIG. 3 illustrates radio integrated circuit (IC) circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage controlled oscillator (VCO), although that is not a requirement. A divider control input may further be provided by either the baseband processing circuitry 108 (FIG. 1) or the application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by the application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

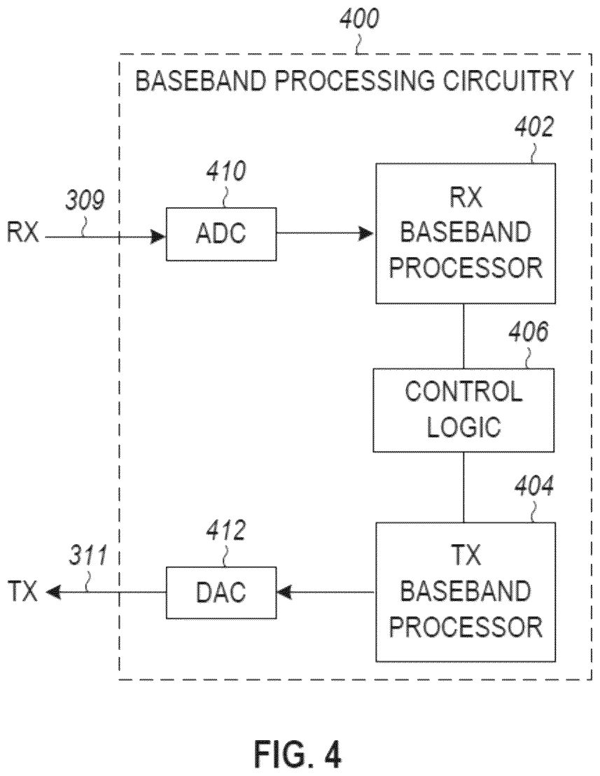

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

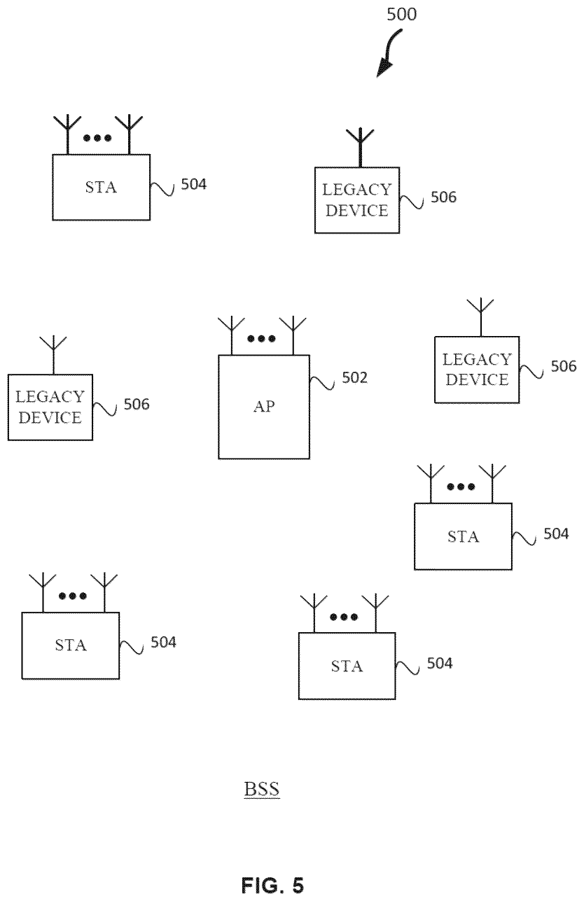

FIG. 5 illustrates a WLAN 500 in accordance with some embodiments. The WLAN 500 may comprise a basis service set (BSS) that may include an access point (AP) 502, a plurality of stations (STAs) 504, and a plurality of legacy devices 506. In some embodiments, the STAs 504 and/or AP 502 are configured to operate in accordance with IEEE 802.11be extremely high throughput (EHT) and/or high efficiency (HE) IEEE 802.11ax. In some embodiments, the STAs 504 and/or AP 520 are configured to operate in accordance with IEEE 802.11az. In some embodiments, IEEE 802.11EHT may be termed Next Generation 802.11.

The AP 502 may be an AP using the IEEE 802.11 to transmit and receive. The AP 502 may be a base station. The AP 502 may use other communications protocols as well as the IEEE 802.11 protocol. The EHT protocol may be termed a different name in accordance with some embodiments. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one EHT AP 502 that is part of an extended service set (ESS). A controller (not illustrated) may store information that is common to the more than one APs 502 and may control more than one BSS, e.g., assign primary channels, colors, etc. AP 502 may be connected to the internet.

The legacy devices 506 may operate in accordance with one or more of IEEE 802.11 a/b/g/n/ac/ad/af/ah/aj/ay/ax, or another legacy wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11be or another wireless protocol.

The AP 502 may communicate with legacy devices 506 in accordance with legacy IEEE 802.11 communication techniques. In example embodiments, the H AP 502 may also be configured to communicate with STAs 504 in accordance with legacy IEEE 802.11 communication techniques.

In some embodiments, a HE or EHT frames may be configurable to have the same bandwidth as a channel. The HE or EHT frame may be a physical Layer Convergence Procedure (PLCP) Protocol Data Unit (PPDU). In some embodiments, PPDU may be an abbreviation for physical layer protocol data unit (PPDU). In some embodiments, there may be different types of PPDUs that may have different fields and different physical layers and/or different media access control (MAC) layers. For example, a single user (SU) PPDU, multiple-user (MU) PPDU, extended-range (ER) SU PPDU, and/or trigger-based (TB) PPDU. In some embodiments EHT may be the same or similar as HE PPDUs.

The bandwidth of a channel may be 20 MHz, 40 MHz, or 80MHZ, 80+80 MHz, 160 MHz, 160+160 MHz, 320 MHz, 320+320 MHz, 640 MHz bandwidths. In some embodiments, the bandwidth of a channel less than 20 MHz may be 1 MHz, 1.25 MHz, 2.03 MHz, 2.5 MHz, 4.06 MHZ, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or subcarriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA HE PPDU formats. In some embodiments, the 106-subcarrier RU is used in the 20 MHz, 40 MHz, 80 MHZ, 160 MHz and 80+80 MHz OFDMA and MU-MIMO HE PPDU formats. In some embodiments, the 242-subcarrier RU is used in the 40 MHz, 80 MHZ, 160 MHz and 80+80 MHz OFDMA and MU-MIMO HE PPDU formats. In some embodiments, the 484-subcarrier RU is used in the 80 MHZ, 160 MHz and 80+80 MHz OFDMA and MU-MIMO HE PPDU formats. In some embodiments, the 996-subcarrier RU is used in the 160 MHz and 80+80 MHz OFDMA and MU-MIMO HE PPDU formats.

A HE or EHT frame may be configured for transmitting a number of spatial streams, which may be in accordance with MU-MIMO and may be in accordance with OFDMA. In other embodiments, the AP 502, STA 504, and/or legacy device 506 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, low-power BlueTooth®, or other technologies.

In accordance with some IEEE 802.11 embodiments, e.g., IEEE 802.11EHT/ax embodiments, a HE AP 502 may operate as a master station which may be arranged to contend for a wireless medium (e.g., during a contention period) to receive exclusive control of the medium for a transmission opportunity (TXOP). The AP 502 may transmit an EHT/HE trigger frame transmission, which may include a schedule for simultaneous UL/DL transmissions from STAs 504. The AP 502 may transmit a time duration of the TXOP and sub-channel information. During the TXOP, STAs 504 may communicate with the AP 502 in accordance with a non-contention based multiple access technique such as OFDMA or MU-MIMO. This is unlike conventional WLAN communications in which devices communicate in accordance with a contention-based communication technique, rather than a multiple access technique. During the HE or EHT control period, the AP 502 may communicate with stations 504 using one or more HE or EHT frames. During the TXOP, the HE STAs 504 may operate on a sub-channel smaller than the operating range of the AP 502. During the TXOP, legacy stations refrain from communicating. The legacy stations may need to receive the communication from the HE AP 502 to defer from communicating.

In accordance with some embodiments, during the TXOP the STAs 504 may contend for the wireless medium with the legacy devices 506 being excluded from contending for the wireless medium during the master-sync transmission. In some embodiments the trigger frame may indicate an UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the HE or EHT TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy stations 506 and/or STAs 504 in accordance with legacy IEEE 802.11 communication techniques. In some embodiments, the AP 502 may also be configurable to communicate with STAs 504 outside the TXOP in accordance with legacy IEEE 802.11 or IEEE 802.11EHT/ax communication techniques, although this is not a requirement.

In some embodiments the STA 504 may be a “group owner” (GO) for peer-to-peer modes of operation. A wireless device may be a STA 502 or a HE AP 502.

In some embodiments, the STA 504 and/or AP 502 may be configured to operate in accordance with IEEE 802.11mc. In example embodiments, the radio architecture of FIG. 1 is configured to implement the STA 504 and/or the AP 502. In example embodiments, the front-end module circuitry of FIG. 2 is configured to implement the STA 504 and/or the AP 502. In example embodiments, the radio IC circuitry of FIG. 3 is configured to implement the HE station 504 and/or the AP 502. In example embodiments, the base-band processing circuitry of FIG. 4 is configured to implement the STA 504 and/or the AP 502.

In example embodiments, the STAs 504, AP 502, an apparatus of the STA 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein described in conjunction with FIGS. 1-13.

In example embodiments, the STAs 504 and/or the HE AP 502 are configured to perform the methods and operations/functions described herein in conjunction with the figures herein. The term Wi-Fi may refer to one or more of the IEEE 802.11 communication standards. AP and STA may refer to EHT/HE access point and/or EHT/HE station as well as legacy devices 506.

In some embodiments, a HE AP STA refers to an AP 502 and/or STAs 504 that are operating as EHT APs 502. In some embodiments, when a STA 504 is not operating as an AP, it may be referred to as a non-AP STA or non-AP. In some embodiments, STA 504 may be referred to as either an AP STA or a non-AP.

In some embodiments, a physical layer protocol data unit (PPDU) may be a physical layer conformance procedure (PLCP) protocol data unit (PPDU). In some embodiments, the AP 502 and STAs 504 may communicate in accordance with one of the IEEE 802.11 standards such as 11be, 11r, 11i, and/or 11w. IEEE P802.11be™/D1.0, May 2021, IEEE P802.11, December 2020, and IEEE P802.11 ax are incorporated herein by reference.

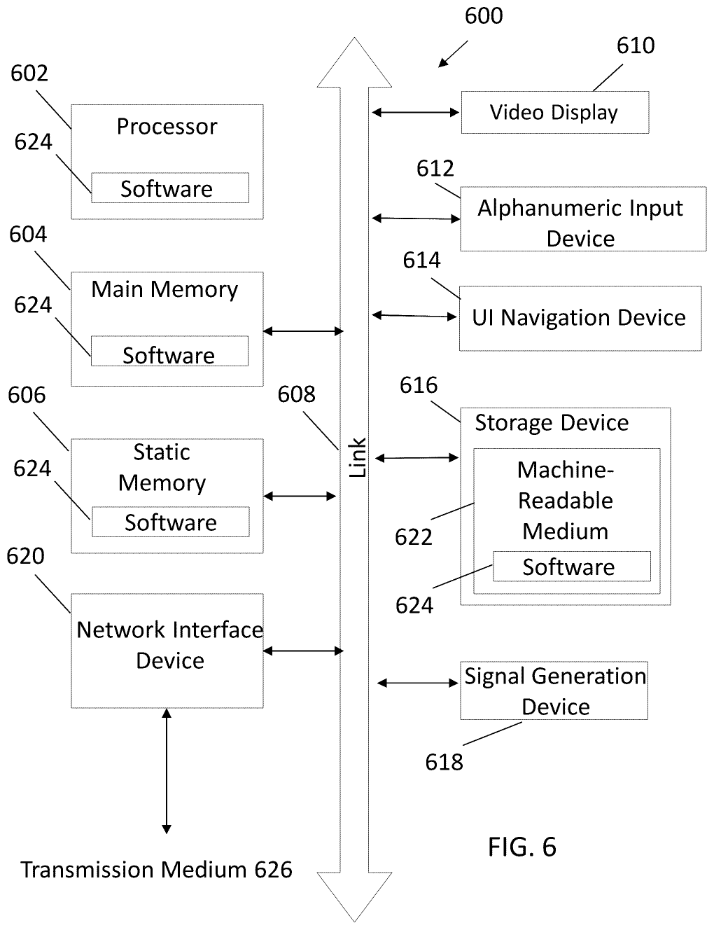

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a HE AP 502, EVT station 504, personal computer (PC), a tablet PC, a set-top box (STB), a personal digital assistant (PDA), a portable communications device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608.

Specific examples of main memory 604 include Random Access Memory (RAM), and semiconductor memory devices, which may include, in some embodiments, storage locations in semiconductors such as registers. Specific examples of static memory 606 include non-volatile memory, such as semiconductor memory devices (e.g., Electrically Programmable Read-Only Memory (EPROM), Electrically Erasable Programmable Read-Only Memory (EEPROM)) and flash memory devices: magnetic disks, such as internal hard disks and removable disks: magneto-optical disks: RAM: and CD-ROM and DVD-ROM disks.

The machine 600 may further include a display device 610, an input device 612 (e.g., a keyboard), and a user interface (UI) navigation device 614 (e.g., a mouse). In an example, the display device 610, input device 612 and UI navigation device 614 may be a touch screen display. The machine 600 may additionally include a mass storage (e.g., drive unit) 616, a signal generation device 618 (e.g., a speaker), a network interface device 620, and one or more sensors, such as a global positioning system (GPS) sensor, compass, accelerometer, or other sensor. The machine 600 may include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 602 and/or instructions 624 may comprise processing circuitry and/or transceiver circuitry.

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

Specific examples of machine readable media may include: non-volatile memory, such as semiconductor memory devices (e.g., EPROM or EEPROM) and flash memory devices: magnetic disks, such as internal hard disks and removable disks: magneto-optical disks: RAM: and CD-ROM and DVD-ROM disks.

While the machine readable medium 622 is illustrated as a single medium, the term “machine readable medium” may include a single medium or multiple media (e.g., a centralized or distributed database, and/or associated caches and servers) configured to store the one or more instructions 624.

An apparatus of the machine 600 may be one or more of a hardware processor 602 (e.g., a central processing unit (CPU), a graphics processing unit (GPU), a hardware processor core, or any combination thereof), a main memory 604 and a static memory 606, sensors, network interface device 620, antennas, a display device 610, an input device 612, a UI navigation device 614, a mass storage 616, instructions 624, a signal generation device 618, and an output controller. The apparatus may be configured to perform one or more of the methods and/or operations disclosed herein. The apparatus may be intended as a component of the machine 600 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices: magnetic disks, such as internal hard disks and removable disks; magneto-optical disks; Random Access Memory (RAM); and CD-ROM and DVD-ROM disks. In some examples, machine readable media may include non-transitory machine-readable media. In some examples, machine readable media may include machine readable media that is not a transitory propagating signal.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 620 may include one or more physical jacks (e.g., Ethernet, coaxial, or phone jacks) or one or more antennas to connect to the communications network 626. In an example, the network interface device 620 may include one or more antennas to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques. The term “transmission medium” shall be taken to include any intangible medium that is capable of storing, encoding or carrying instructions for execution by the machine 600, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM): random access memory (RAM): magnetic disk storage media: optical storage media: flash memory, etc.

### 5G Mm Wave AiM Module in Barrel Hinge

As above, the desire to incorporate the ability to use mmWave communications in electronic devices has become of increasing interest with the advent of protocols for using such communications. However, to use mmWave signals, a particular piece of electronics may be redesigned to accommodate multiple mmWave AiM modules (also referred to herein as antenna modules or AiMs), as well as Wi-Fi and 5G sub-6 GHz antennas. This may be problematic in electronics with limited space, such as portable computers (such as laptops). The availability of additional space inside a laptop chassis to mount the additional (mmWave) antennas is a challenge considering the thin form factor of present laptops. The placement of mmWave modules in a laptop chassis may use a plastic opening over a C-cover of the laptop. This may directly impact the ID and/or thermal performance of the laptop. Note that the A-cover is the top of the display portion of the laptop, the B-cover is the bottom of the display portion (which contains the actual display), the C-cover is the top of the base (which contains one or more processors, as well as input devices including keyboard and mousepad, among others), and the D-cover is the bottom of the base.

The hinge mechanism herein enables placement of a 5G mmWave AiM module inside a barrel hinge cap of a laptop with wider radiation coverage in different laptop use cases. The hinge mechanism, along with a removable antenna holder, may fulfill mechanical, thermal, RF and radiation requirements of the mmWave AiM module. Replacement of mmWave FPCs with cable routing with the routing mechanism herein may allow placement of the mmWave module in a compact barrel hinge. Cable clamps are designed to fix cable movement near the antenna region, specifically in case of lid movement to prevent contact of cables with antenna connectors. This makes cable routing more reliable.

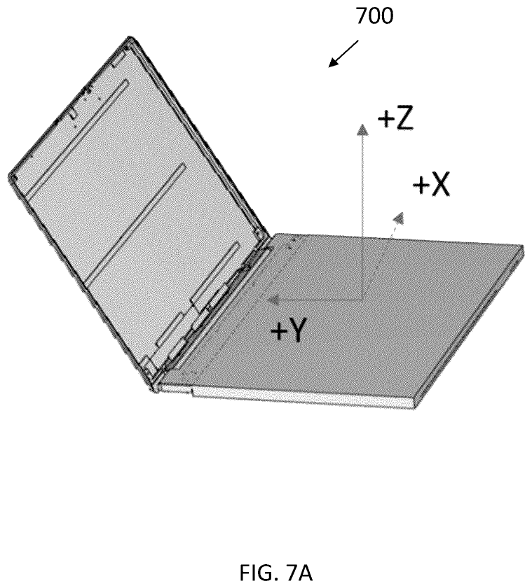

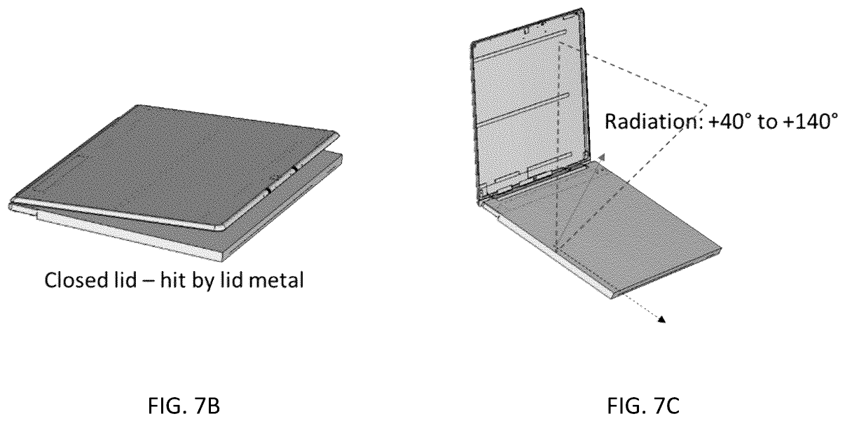

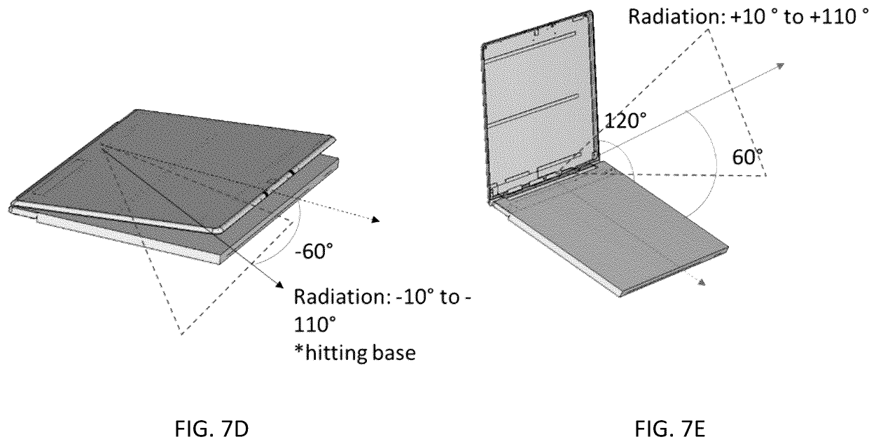

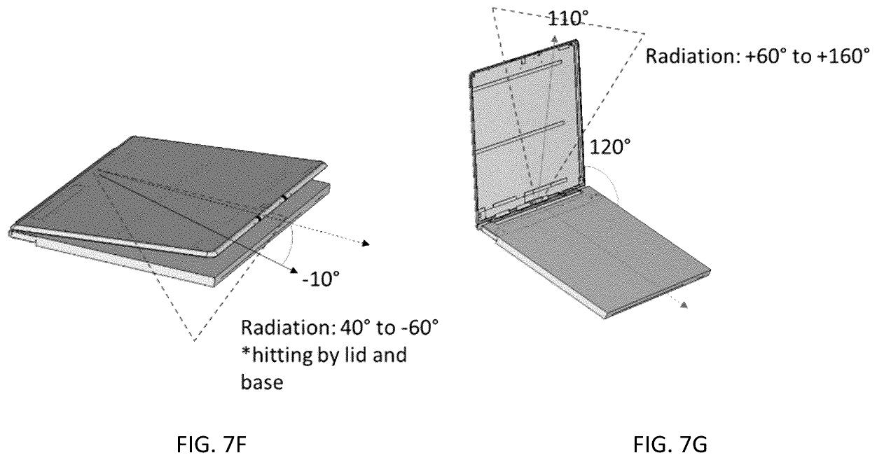

FIG. 7A illustrates radiation axes for a laptop in accordance with some embodiments. As 5G mmWave modules are directional in nature, FIG. 7A shows the multiple directions with respect to the laptop 700. Multiple AiM modules may thus be used cover multiple directions (in upper hemisphere) with good connectivity. The 5G mmWave modules are directional and may typically cover an angular range from −50° to +50° angle. It may be desirable for AiM modules to fire (emit) towards the +X, +Y, and +Z directions as shown. Mechanically, AiM modules may easily be placed to fire towards the +X, −X and −Y directions (from a user experience standpoint, AiM modules that fire in the −Y and −Z directions may be less preferable). This may accordingly leave the +Y and +Z directions remaining for the AiM modules to fire.

FIG. 7B illustrates radiation for a closed lid laptop with a top firing AiM module in accordance with some embodiments. FIG. 7C illustrates radiation for an open lid laptop with a top firing AiM module in accordance with some embodiments. To cover the +Z direction, one possible location of the AiM module is in base of the laptop with a firing upward direction. Placement in the lid may not be feasible due to high insertion loss of the transmission lines to the AiM module. However, a placement in the base of the laptop may directly impact the ID and thermal characteristics of the AiM module. Also, such a placement may not allow the AiM module to operate effectively when the lid of the laptop is closed, as shown in FIGS. 7A and 7B.

FIG. 7D illustrates radiation for a closed lid laptop with a 60° firing AiM module in accordance with some embodiments. FIG. 7E illustrates radiation for an open lid laptop with a 60° firing AiM module in accordance with some embodiments. FIG. 7F illustrates radiation for a closed lid laptop with a 110° firing AiM module in accordance with some embodiments. FIG. 7G illustrates radiation for an open lid laptop with a 110° firing AiM module in accordance with some embodiments. FIGS. 7D-7G thus illustrate use case scenarios for an AiM module disposed inside a barrel of the laptop (that connects the lid and the base of the laptop). However, with movement of the lid, the antenna placed inside will also rotate, which may lead to challenges that include routing cable/FPC placement, maintaining all mode performance, etc. In addition, such a placement still may not allow the AiM module to operate effectively when the lid of the laptop is closed.

As can be seen in FIGS. 7A-7G, the AiM module radiation coverage may be limited at best in closed lid mode of the laptop. For laptops having a barrel hinge, placement of a mmWave module that works for different use cases may be challenging, and implementation challenges may exist if the module is placed inside the barrel hinge.

Notably, an empty space may be present inside the barrel hinge cap. The barrel hinge cap may be formed, in some examples, from plastic material. The barrel hinge cap may be a suitable location for the antenna placement. Using this space, plastic cutouts can be avoided in the all-metal chassis of the laptop for antenna radiation. However, limitations of hinge mechanism remain. These limitations include maintaining/obtaining antenna performance (having directional radiation characteristics) when antenna module rotates along with lid movement, all peripherals inside the barrel hinge rotate with the lid movement, and routing of the antenna module FPCs/cables inside the barrel hinge (notably to avoid damage of the cables).

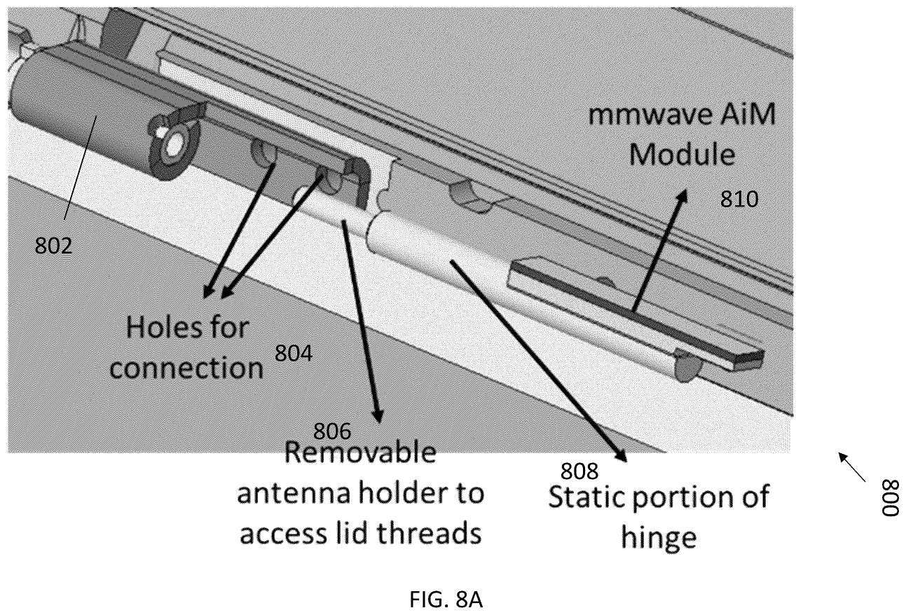

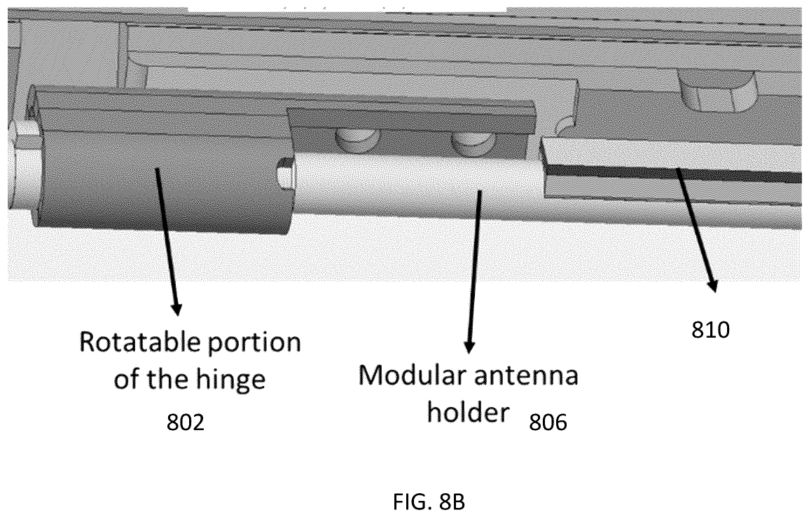

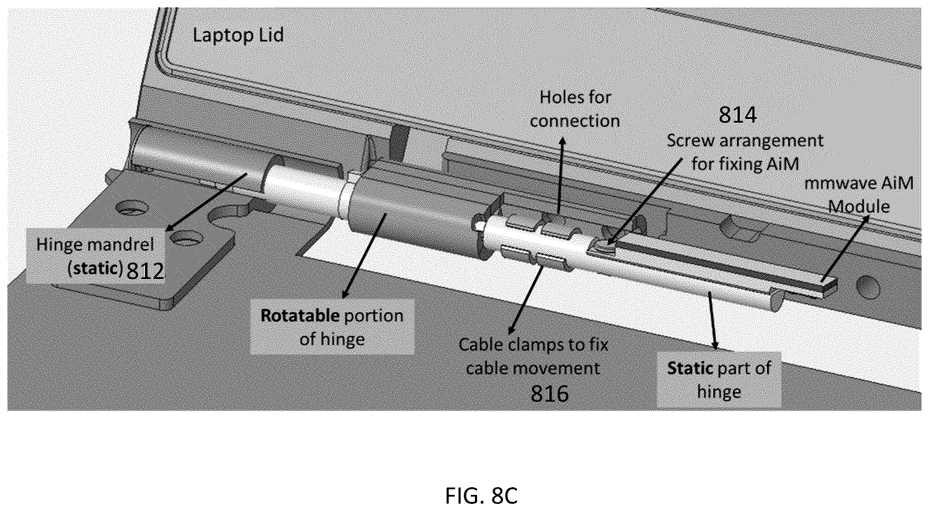

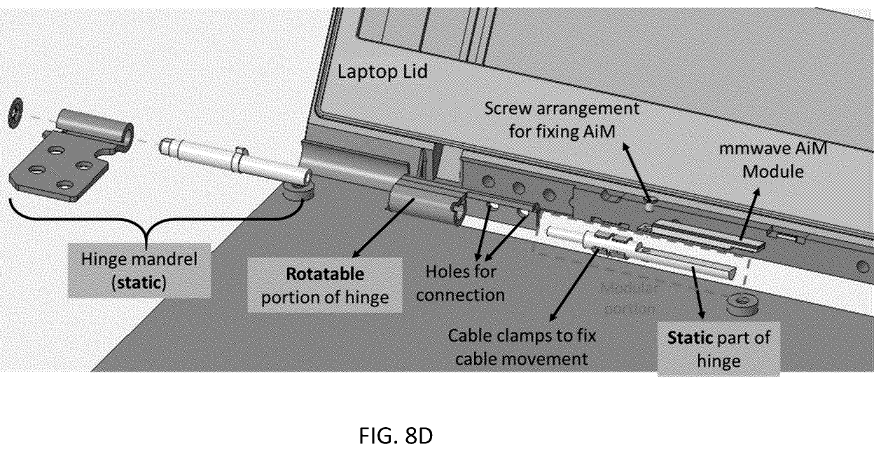

A modular hinge antenna holder may be used to avoid the above-mentioned limitations and place one or more directional mmWave antennas inside the barrel. FIG. 8A illustrates a modular hinge antenna holder in accordance with some embodiments. FIG. 8B illustrates another view of the modular hinge antenna holder of FIG. 8A in accordance with some embodiments. FIG. 8C illustrates another view of the modular hinge antenna holder of FIG. 8A in accordance with some embodiments. FIG. 8D illustrates an exploded view of the modular hinge antenna holder of FIG. 8A in accordance with some embodiments. The modular hinge antenna holder structure 800 shown in FIGS. 8A-8D includes a rotatable hinge portion 802, with holes 804 for connection to the laptop chassis. A removable antenna holder 806 is disposed to access threads of the laptop lid. The hinge contains a static portion 808 having a portion that may be retained in a static hinge mandrel 812. A mmWave AiM module 810 may be disposed on another portion of the static portion 808 of the hinge. The mmWave AiM module 810 may have dimensions of, for example, about 22 mm×about 3 mm×about 2.5 mm. As shown, the static portion 808 of the hinge may be connected to the metal chassis with one or more screws (or other fasteners) 814 and hence may itself provide good heat dissipation for the mmWave AiM module 810. Cable clamps 816 may be used to fix cable movement to the mmWave AiM module 810, which does not rotate.

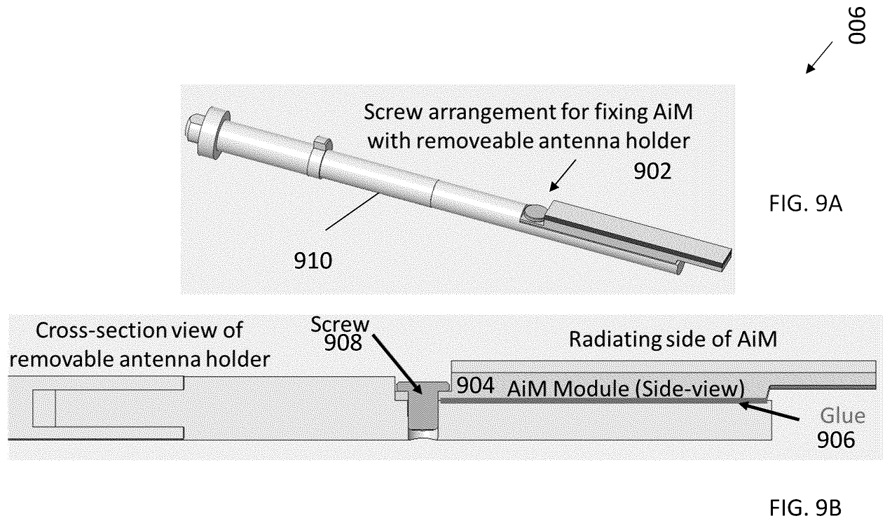

FIG. 9A illustrates an arrangement for preventing vibration to AiM module in accordance with some embodiments. FIG. 9B illustrates another view of the arrangement of FIG. 9A in accordance with some embodiments. The overall arrangement 900 includes a screw 908 used to connect the screw arrangement 902 to the removeable hinge 910. To reduce vibrations affecting the mmWave AiM module 904, the mmWave AiM module 904 may be pasted with metallic glue 906 (or another adherent) to form the screw arrangement 902 prior to connecting the screw arrangement 902 to the removeable hinge 910.

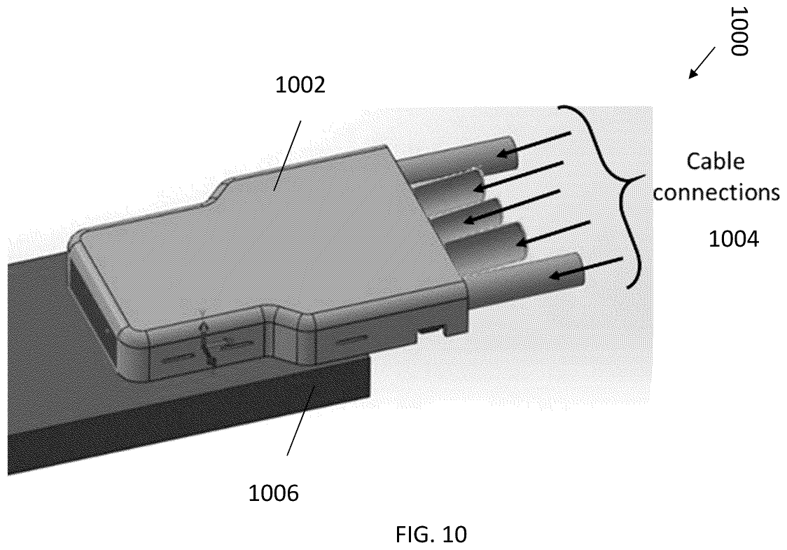

As above, FPCs may be used to route the cables for the mmWave AiM module. However, routing of the FPCs inside the barrel hinge along with lid cable bundle may be challenging due to less space being available. Accordingly, FPCs may be replaced with cables to provide the inputs to the mmWave AiM module through direct coupling to the AiM module. FIG. 10 illustrates cable routing to enable placement in a barrel hinge in accordance with some embodiments. The splitting of the cables 1004 may be located near a base area of the connector 1002 to accommodate the cables for the mmWave AiM module 1006 in the system 1000 shown in FIG. 10.

Here, in a bundle, routing of the cables 1004 may be:

| Sr. | Type of Inputs for | | |
|---|---|---|---|
| No. | mmWave AiM module | Qty | Details |
| 1 | IF cables | 2 | Up to 8 GHz (0.8 mm diameter) |
| 2 | Vsys | 1 | 1.2 Amps (0.6 mm diameter) |
| 3 | Vref | 1 | 90 mAmps (0.2 mm diameter) |
| 4 | GPIO | 1 | 0.3 mm diameter |

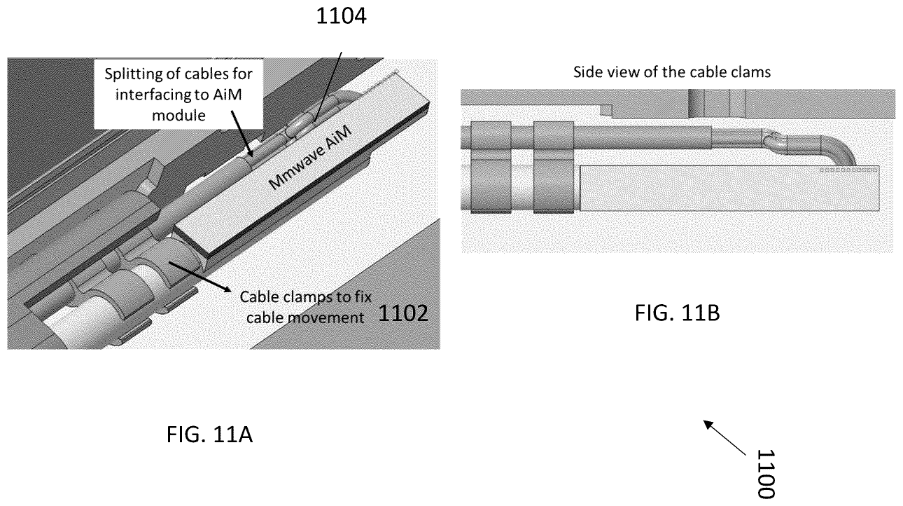

FIG. 11A illustrates cable clamps for fixing cable movement in accordance with some embodiments. FIG. 11B illustrates a side view of the cable clamps of FIG. 11A in accordance with some embodiments. FIGS. 11A and 11B show an arrangement 1100 in which the cable clamps 1102 are used to secure cables (carrying signals) attached to the mmWave AiM module 1104 so that the cables do not move (which may reduce the cable breakage).

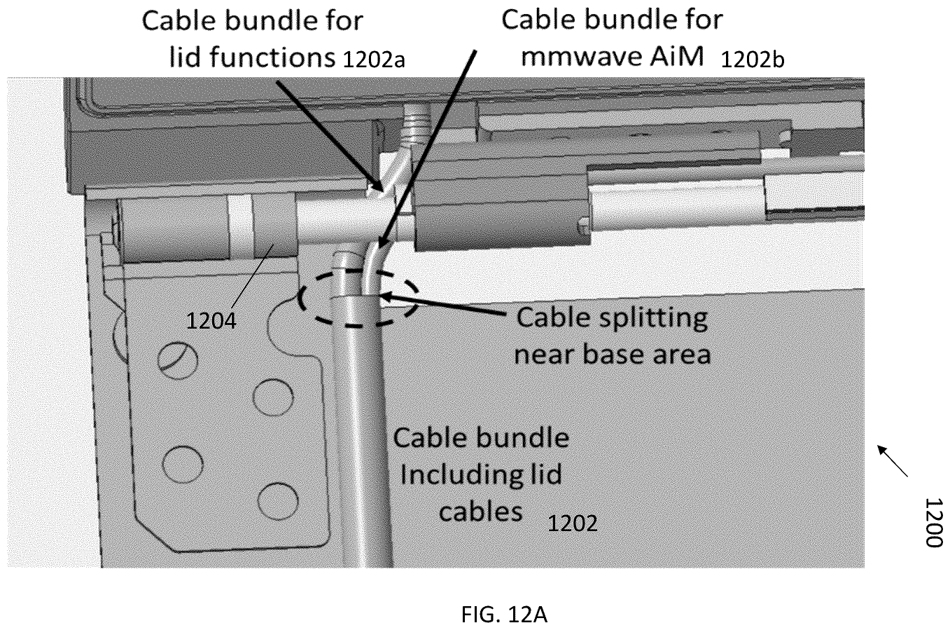

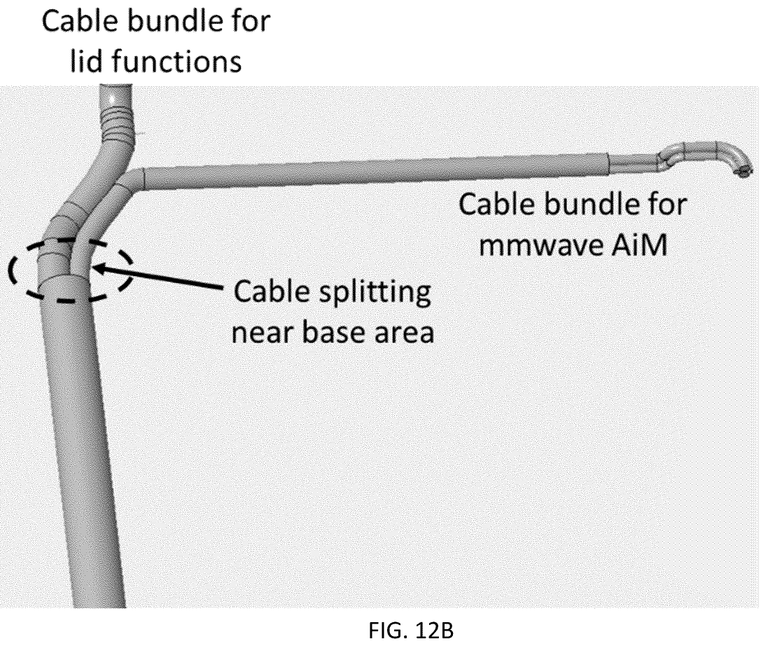

FIG. 12A illustrates cable splitting for a mmWave AiM module near hinge in accordance with some embodiments. FIG. 12B illustrates another view of the cable splitting of FIG. 12A in accordance with some embodiments. FIGS. 12A and 12B show an arrangement 1200 in which the cable bundle 1202 is split into a cable bundle for functions of the lid of the laptop 1202a and a cable bundle for the mmWave AiM module 1202b. The cable bundle 1202 is split near the base area of the hinge 1204.

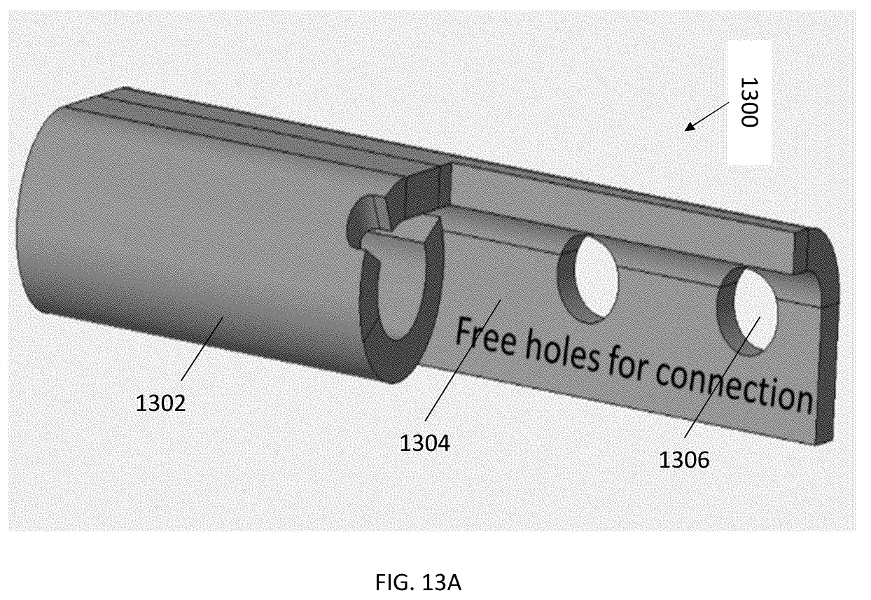

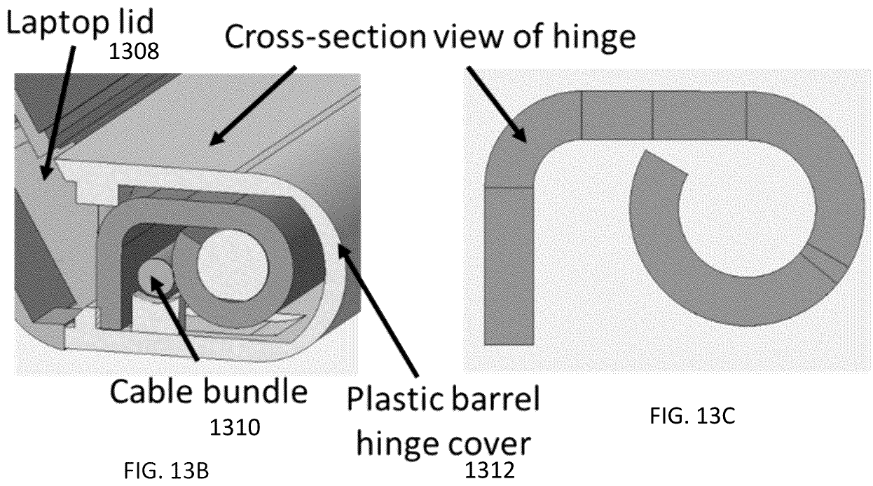

FIG. 13A illustrates a modular hinge mechanism in accordance with some embodiments. FIG. 13B illustrates a cross-sectional view of the modular hinge mechanism of FIG. 13A in accordance with some embodiments. FIG. 13C illustrates another cross-sectional view of the modular hinge mechanism of FIG. 13A in accordance with some embodiments. Thus, FIGS. 13A-13C illustrate closeups of the modular hinge mechanism 1300. The modular hinge mechanism 1300 includes a retaining portion 1302 that may be used to retain the mandrel. A connection portion 1304 extends from the retaining portion 1302. Holes 1306 in the connection portion 1304 are sized to fit connectors such as screws to the case of the laptop lid 1308. The modular hinge mechanism 1300 and cable bundle 1310 may be retained within a cover 1312, which may be formed from a flexible material such as plastic

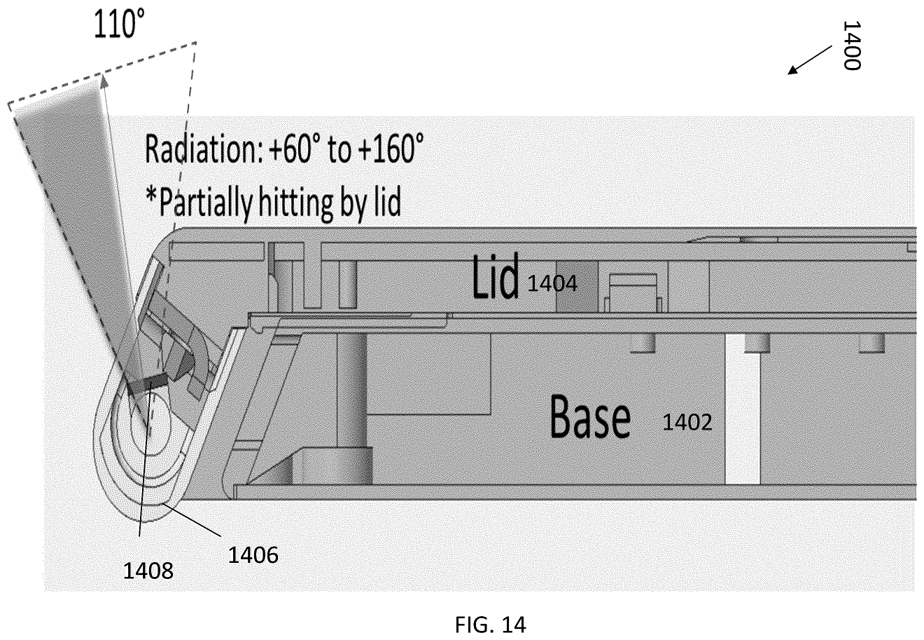

FIG. 14 illustrates a closed lid view for a static barrel hinge in accordance with some embodiments. FIG. 14 shows a cross-sectional view of a portion of a laptop 1400 that includes a base 1402 and a lid 1404 of the laptop 1400 connected by the modular hinge mechanism 1406. As illustrated in FIG. 14, when the laptop 1400 is closed, the mmWave AiM module 1408 may be able to rotate and provide connectivity (i.e., radiate) in an angular range of about 110° from about 60° to about 160°. The radiation from the mmWave AiM module 1408 may partially interact with the lid 1404 of the laptop 1400, thereby somewhat reducing the angular range of radiation.

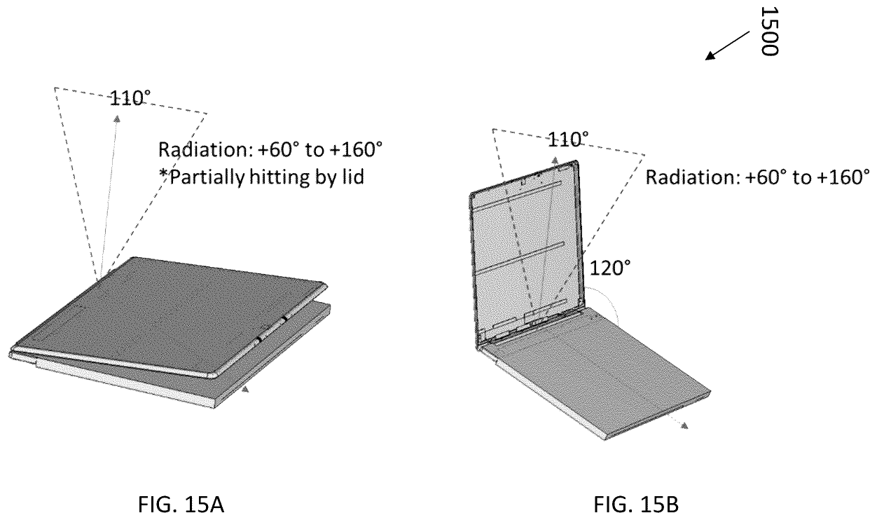

FIG. 15A illustrates radiation for a closed lid laptop with a 110° firing AiM module with a static hinge in accordance with some embodiments. FIG. 15B illustrates radiation for an open lid laptop with a 110° firing AiM module with a static hinge in accordance with some embodiments. FIGS. 15A and 15B thus show use cases (open/closed) 1500 of a laptop that contains the mmWave AiM module in the modular hinge mechanism. As above, independent of whether the laptop is open or closed, the mmWave AiM module rotates to radiate in an angular range of about 110° (from about 60° to about) 160° from a plane of the surface of the laptop base. Note that while a laptop is described herein, any hinged electronic device (e.g., smartphone) may include the mmWave AiM module in a similar manner.

### Base Station-Assisted Mm Wave Antenna Module Rotation Algorithm

In some embodiments, multiple mmWave AiM modules may be used to meet the cumulative distribution function (CDF) requirement defined by the standards and network operators. However, as the addition of multiple AiM modules adds to the cost and system complexity, it is desirable to meet the CDF requirement using a minimum number of AiM modules. Accordingly, some embodiments may provide a base station-assisted rotatable AiM module, whose rotation may be based on the location coordinates of the base station. In this case, a mmWave base station with which the electronic device (e.g., laptop, mobile device) is connected may share the location coordinates through the LTE/NR link between the laptop and the base station. The electronic device may also acquire its own location coordinates from a built-in GNSS/WLAN and then determine its current position and orientation with respect to the mmWave base station using a compass and built-in sensor as described above. Using the above parameters, the electronic device may then calculate the amount of rotation to align the AiM module in the direction of the mmWave base station and rotates the AiM module accordingly.

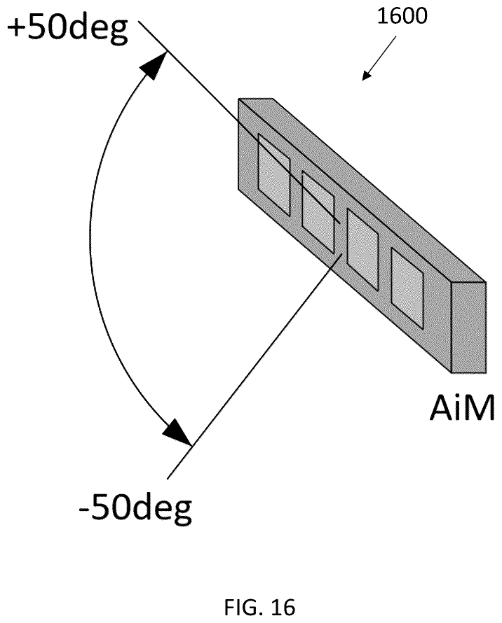

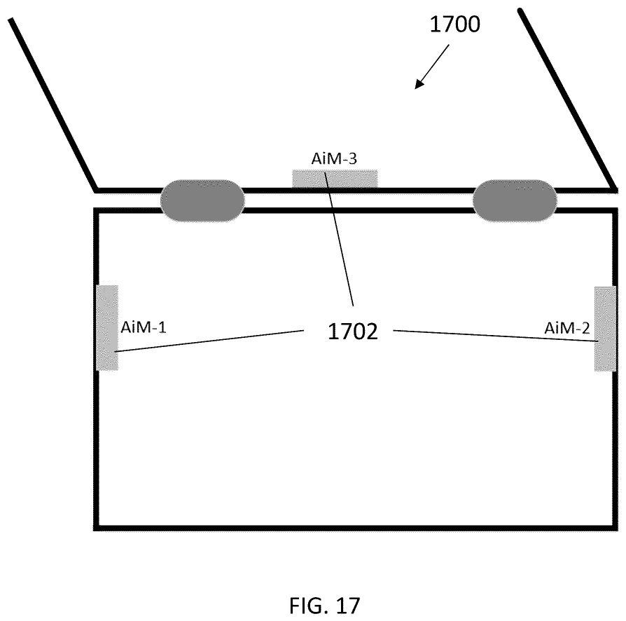

FIG. 16 illustrates an AiM module in accordance with some embodiments. The AiM module 1600 shown in FIG. 16 may be stationary and may cover an angular range of, for example, about 100° (as shown about −50° to about +50°). FIG. 17 illustrates a laptop with multiple AiM modules in accordance with some embodiments. Three separate AiM modules 1702 are disposed in the laptop 1700.

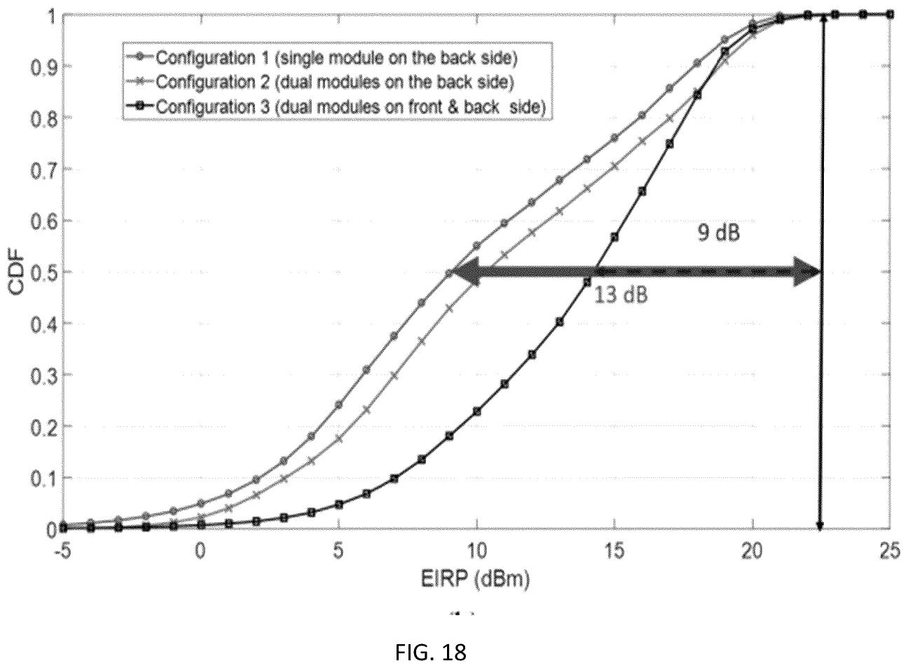

FIG. 18 illustrates EIRP of a laptop with multiple AiM modules in accordance with some embodiments. CDF is cumulative response gain, or power measured for steering angles for each array. CDF indicates what percentage of a coverage sphere can attain the measured parameter desired/specified value. EIRP CDF is a measure of how much of the sphere can be covered by a certain power level. As shown in FIG. 18, for an EIRP of 10 dBm, in configuration 1 (One AiM module): about 55% of the sphere will have a power less than 10 dBm: in configuration 2 (Two AiM modules): about 48% of the sphere will have power less than 10 dBm: in configuration 3 (Three or more AiM modules): about 22% of the sphere will have power less than 10 dBm. It is clear that the use of an increasing number of AiM modules may provide increasingly better coverage, albeit at increased cost and complexity.

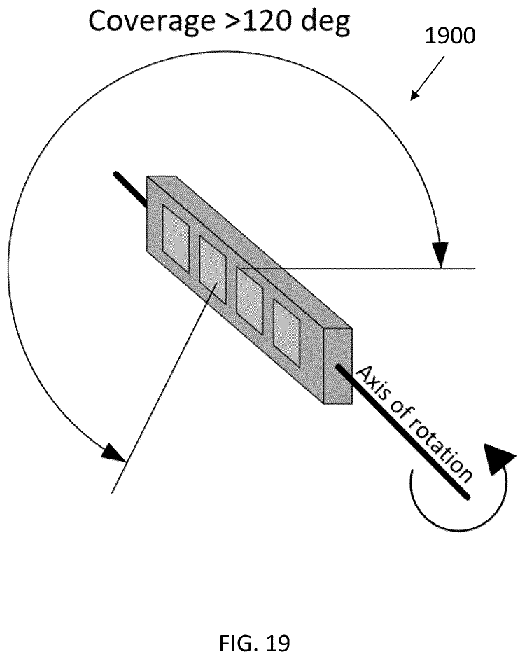

FIG. 19 illustrates a rotatable mmWave AiM module in accordance with some embodiments. The AiM module 1900 shown in FIG. 19 may be rotatable and may cover an angular range of, for example, greater than about 120°. In this case, the number of AiM modules 1900 used may be reduced to one or two to maintain the EIRP.

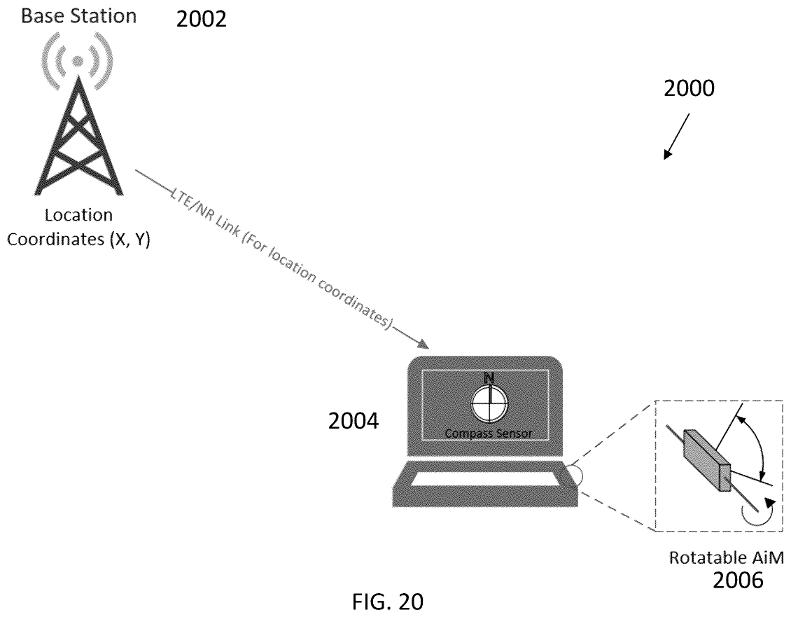

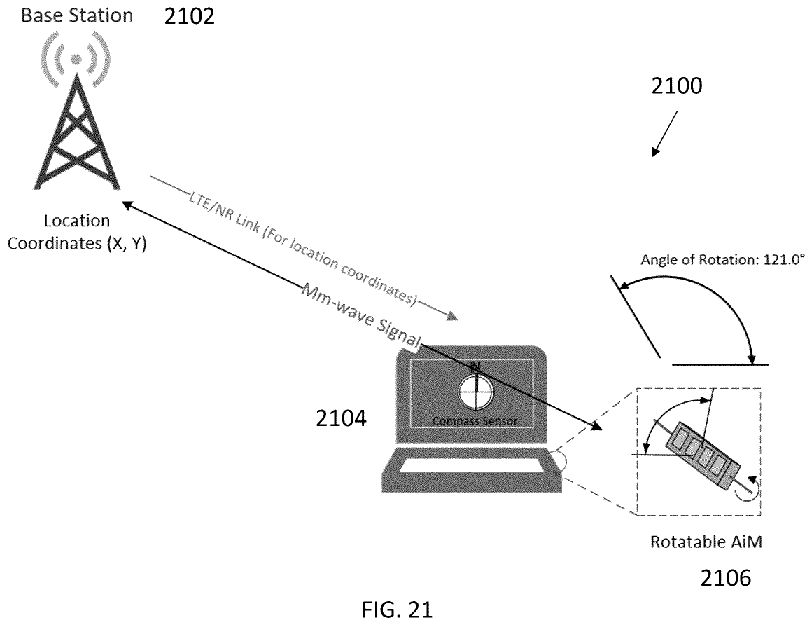

FIG. 20 illustrates a system with a laptop with a rotatable AiM module in accordance with some embodiments. FIG. 21 illustrates communications in a system with a laptop with a rotatable AiM module in accordance with some embodiments. As illustrated in the system 2000 of FIG. 20 and 2100 of FIG. 21, the base station 2002, 2102 may assist the rotation of the mmWave AiM module 2006, 2106 in the electronic device 2004, 2104 (shown as a laptop). The base station 2002, 2102 may share its location coordinates to the electronic device 2004, 2104 through downlink communication using the LTE/NR link between the base station 2002, 2102 and the electronic device 2004, 2104. The electronic device 2004, 2104 may obtain its own current location and orientation from the built-in GNSS or WLAN connection. Using both sets of information, the electronic device 2004, 2104 may estimate the direction of signal arrival from the base station 2002, 2102. The location of the AiM module 2006, 2106 on the electronic device 2004, 2104 may be predefined for a given design. Using the built-in compass and predefined AiM module location in the electronic device 2004, 2104, a processor in the electronic device 2004, 2104 may calculate a degree of rotation to align the AiM module 2006, 2106 in the direction of the base station 2002, 2102.

Once the AiM module 2006, 2106 has been controlled to rotate in the direction of base station 2002, 2102, the AiM module 2006, 2106 can track the base station beam and correct the angle of the AiM module 2006, 2106 for minor movements in the system location/direction using beam steering.

In the embodiments shown in FIGS. 20 and 21, a single AiM module 2006, 2106 may be located on the right side of the electronic device 2004, 2104 (shown as the laptop base). For the given orientation of the electronic device 2004, 2104 shown in FIGS. 20 and 21, the base station 2002, 2102 is located on the left side of the electronic device 2004, 2104. As can be seen in FIG. 20, the coverage of the AiM module 2006 is towards right side and the base station 2002 may thus be out of coverage of the AiM module 2006.

As the base station 2002 in FIG. 20 is out of coverage, the electronic device 2004 may initiate the rotation algorithm. The base station 2002 may (periodically or on request) send location coordinates of the base station 2002 to the electronic device 2004 through the downlink LTE/NR connection. The electronic device 2004 may either before or after reception of the location coordinates from the base station 2002 obtain its own location coordinates from a GNSS/WLAN connection. The electronic device 2004 may also obtain its orientation details from the built-in compass or other sensors. By using these inputs, the electronic device 2004 may calculate the angle of rotation to align the AiM module 2006 to the incoming mmWave signal from the base station 2002 and subsequently rotate the AiM module 2006 such that the base station 2002 is within the coverage of AiM module 2006.

As shown in FIG. 21, once the AiM module 2106 has been rotated to latch onto the mmWave signal from the base station 2102, the electronic device 2104 may further use beam steering to track the base station beam if there are any minor movements in the placement/orientation of the electronic device 2104 that are detected by the sensors in the electronic device 2104.

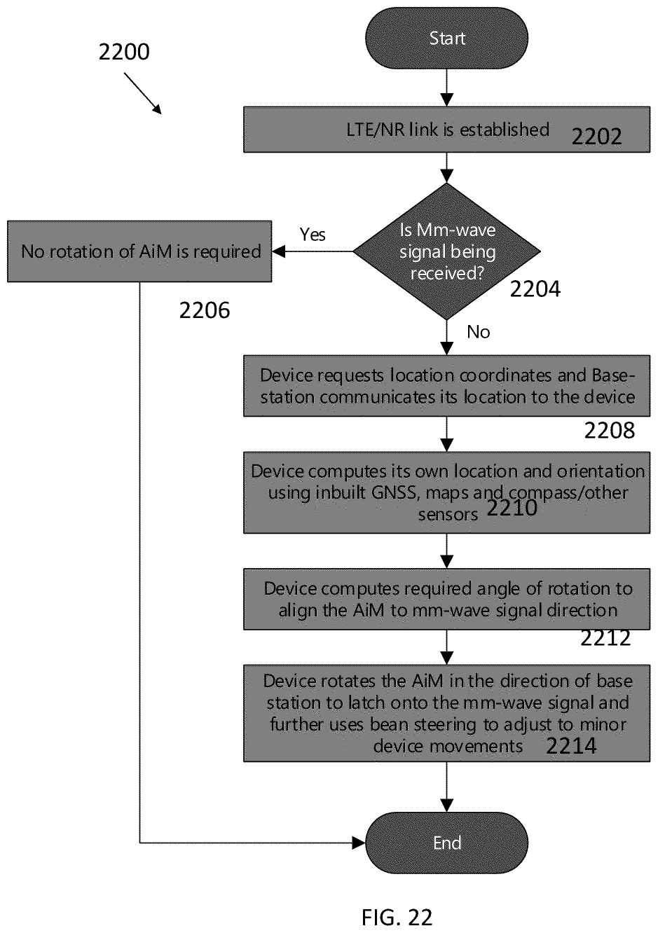

FIG. 22 illustrates a flowchart of use of a rotatable AiM module in accordance with some embodiments. The flowchart 2200 illustrates the operations described above for the system shown in FIGS. 20 and 21. The flowchart 2200 may be performed continuously automatically or triggered by manual activation. The LTE/NR connection may be established between the base station and the electronic device at operation 2202. The electronic device may determine at operation 2204 whether a mmWave signal is being received from the base station, which the electronic has determined is configured to transmit to the electronic device. At operation 2206, if the electronic device determines at operation 2204 that a mmWave signal is being received from the base station, the electronic device may determine that no further rotation of the AiM module is to be undertaken. At operation 2208, if the electronic device determines at operation 2204 that a mmWave signal is not being received from the base station, the electronic device may obtain location coordinates of the base station from the base station. The location coordinates may be sent periodically from the base station to the electronic device or, as shown in the flowchart 2200, transmission of the location coordinates may be triggered by a request from the electronic device. At operation 2210, after obtaining the location coordinates of the base station, the electronic device may determine location coordinates of the electronic device as well as orientation of the electronic device using one or more of GNSS information, maps stored in the electronic device, and compass/gyroscope/other sensor information. Using the information of the base station location and the electronic device location and orientation, at operation 2212 the electronic device may compute the angle of rotation of the AiM module to align the AiM module with the base station in the mmWave signal direction of the base station. Having calculated the angle of rotation at operation 2212, the electronic device may at operation 2214 rotate the AiM module in the mmWave signal direction of the base station to obtain (and maximize) the mmWave signal reception. In some embodiments, the initial rotation is essentially a gross tuning: the AiM module may continue to be rotated by a predetermined amount (e.g., one or two degrees) in each direction to maximize the mmWave signal reception once the mmWave signal has been received. The electronic device may then apply beam steering techniques to adjust to minor changes in the position and orientation of the electronic device (e.g., a few inches and degrees).

The ability to rotate the AiM module(s) may lead to a reduction in the number of AiM modules to be incorporated in the laptop, thereby increasing the design possibilities by reducing the system space constraints, cost, and AiM interconnect complexity while increasing the mmWave link reliability, meeting the CDF requirements, and number of proximity sensors. The AiM module may be disposed at any of the locations described herein (e.g., on one or more of the laptop covers, internal to the chassis, or rotatably disposed in the barrel hinge).

### Magnetic Attachment of AiM Modules on Mobile Systems

As above, enablement of mmWave communications for electronic devices (e.g., laptops) may be challenging when the minimum 3 AiM modules are used to meet the CDF defined by the operator. Each AiM module may use at least 6 signals, including digital and RF signals, for optimum operation. This may add to the cost and area used for the AiM module integration in an electronic device.

To combat the cost and area issues when multiple AiM modules are used, sets of spring loaded pogo-pin based interconnects may be used to enable power, digital, and shielded RF signals interfaces through a single connector, thereby reducing pin count by 10 instead of 24. This reduction may also enable the external plug and play of an AiM module, which brings down the overall system cost for mmWave communications.

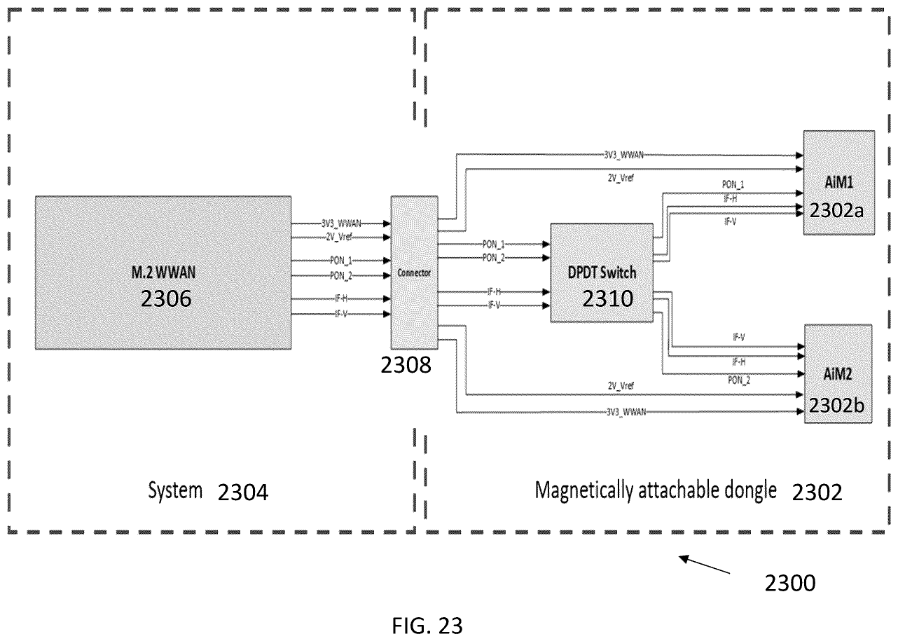

FIG. 23 illustrates a block diagram of an AiM module in accordance with some embodiments. In particular, as shown in the circuit diagram of FIG. 23, the electronic device 2300 may include a magnetically attachable antenna dongle 2302 in which two AiM modules 2302a, 2302b may be placed back-to-back. The AiM modules 2302a, 2302b may be connected to the communication system 2304 of the electronic device 2300. As shown, a wireless wide area network (WWAN) module 2306 (and/or other communication module) is connected to the AiM modules 2302a, 2302b through a connector 2308 and switch 2310.

In some embodiments, the AiM modules 2302a, 2302b may have pogo pin-based interconnects that include the power supply, reference supply, power enable (PON), and intermediate frequency (IF) interface (IF-H, IF-V) with a ground shield. The pin counts for the AiM modules 2302a, 2302b may be reduced by enabling a single IF interface to drive both the AiM modules 2302a, 2302b with the DPDT switch 2310 inside the dongle 2302 to switch the IF interface to the desired AiM module 2302a, 2302b. The real estate area may be reduced inside the electronic device 2300 by moving the AiM modules 2302a, 2302b into the dongle 2302. The M.2 based WWAN module 2306 may communicate with the mmWave interface with the help of the magnetically attached dongle 2302.

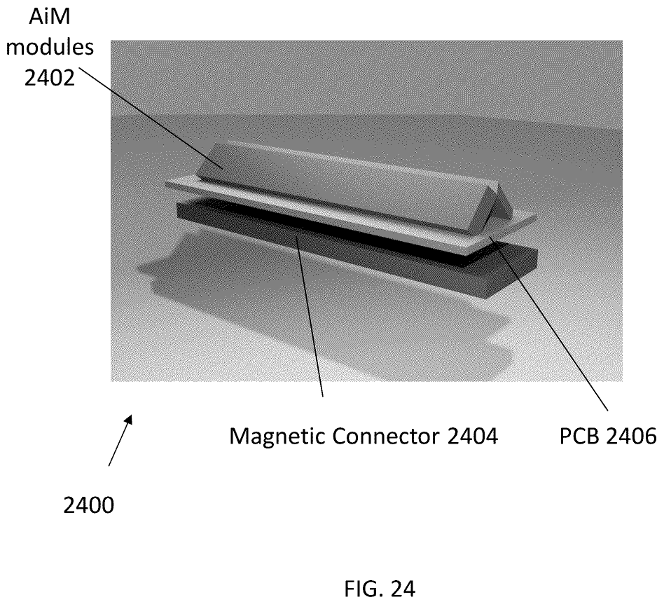

FIG. 24 illustrates AiM modules inside a dongle in accordance with some embodiments. The dongle 2400 includes two AiM modules 2402 disposed at a specific angle (e.g., about a right angle) with respect to each other and connected to a PCB 2406. The dongle 2400 is able to be connected to the laptop (or other device) via a magnetic connector 2404.

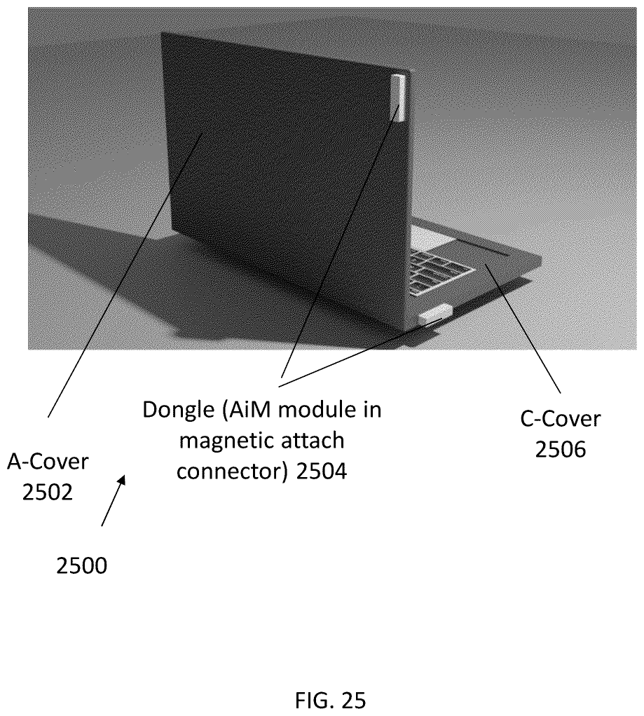

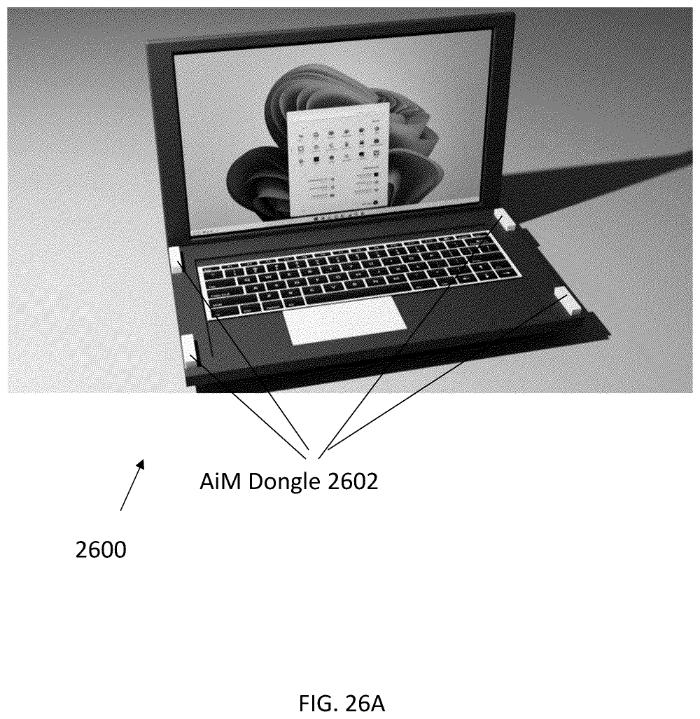

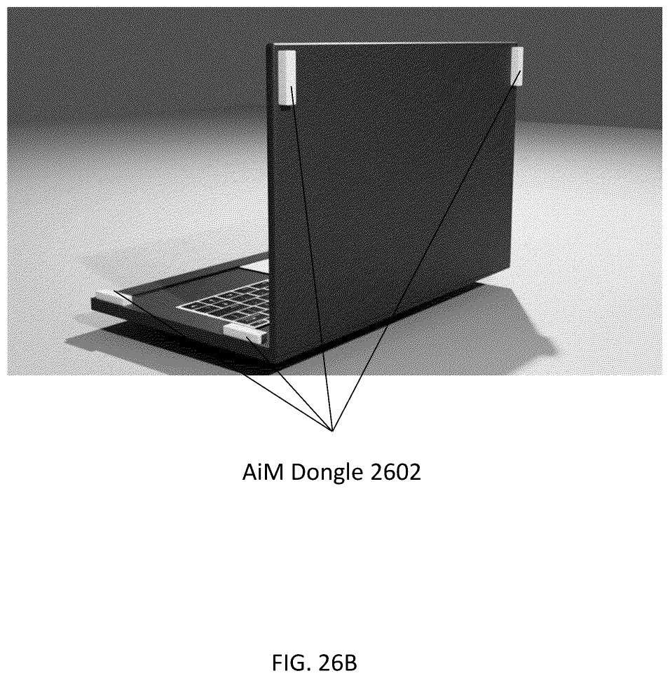

FIG. 25 illustrates a dongle on laptop covers in accordance with some embodiments. The laptop 2500 shown in FIG. 25 may contain an A-cover 2502 and a C-cover 2506, each or both of which may contain one or more areas for connection of the dongle 2504. FIG. 26A illustrates a dongle placement on a laptop cover in accordance with some embodiments. FIG. 26B illustrates a dongle placement on a laptop base in accordance with some embodiments. As shown in FIGS. 26A and 26B, the dongle 2602 may be provided in one or more of different locations on the laptop 2600. The locations may include one or more locations on each of the A-cover or C-cover of the laptop 2600, as shown. This may help to reduce the area occupied by the mmWave solutions and facilitate a compact system design of the laptop 2600. Although not shown, each of the possible locations in which the dongle 2602 may be connected may be covered with a removable cover (e.g., formed from plastic or rubber) to protect the electrical contacts within the area.

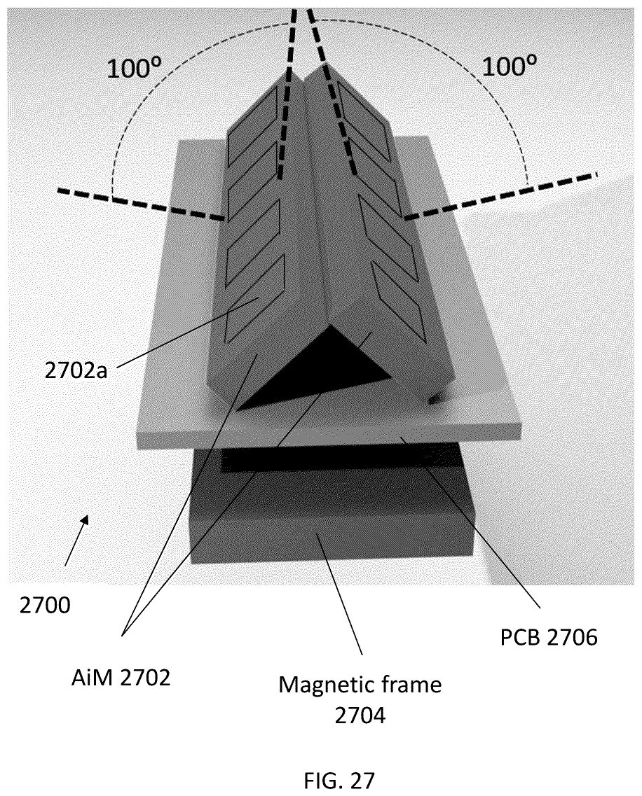

In addition, multiple AiM modules may be controlled using a single IF interface, which may help to reduce the cost incurred by the mmWave communications. FIG. 27 illustrates AiM module radiation coverage in accordance with some embodiments. As shown in FIG. 27, the dongle 2700 includes two AiM modules 2702 disposed at about a right angle with respect to each other and connected to a PCB 2706 (e.g., via an FPC). The dongle 2700 is able to be connected to the laptop (or other device) via a magnetic frame 2704. The AiM modules 2702 each contain multiple radiating elements 2702a (as other AiM modules described herein) to radiate in the mmWave frequency range. The AiM modules 2702 may use a single IF interface (IF-H, IF-V) to drive both AiM modules 2702 with a Double Pole Double Throw (DPDT) switch (see FIG. 23) to switch the IF interface to the appropriate AiM module 2702. The DPDT switch can be controlled by power on (PON) signals of the AiM modules 2702. With help of respective PON signals of the AiM modules 2702, the DPDT switch may turn on and connect to one of the AiM modules 2702 and enable the IF interface, power and reference signals for the AiM module 2702, thereby reducing the dongle connector pin count for the AiM modules 2702 from 24 to 10.

The appropriate AiM module 2702 may be selected using the PON signals based on the CDF difference between the AiM modules 2702. That is, the AiM module 2702 having the higher CDF may be determined and then be selected. Hence, a common power supply can be used for both AiM modules 2702 as only one AiM module 2702 may be operating at one time, thereby reducing the implementation cost. The AiM modules 2702 may be arranged specifically to meet a typical radiation coverage pattern of about 100° (to about 110°, as above) the CDF, as shown in FIG. 27.

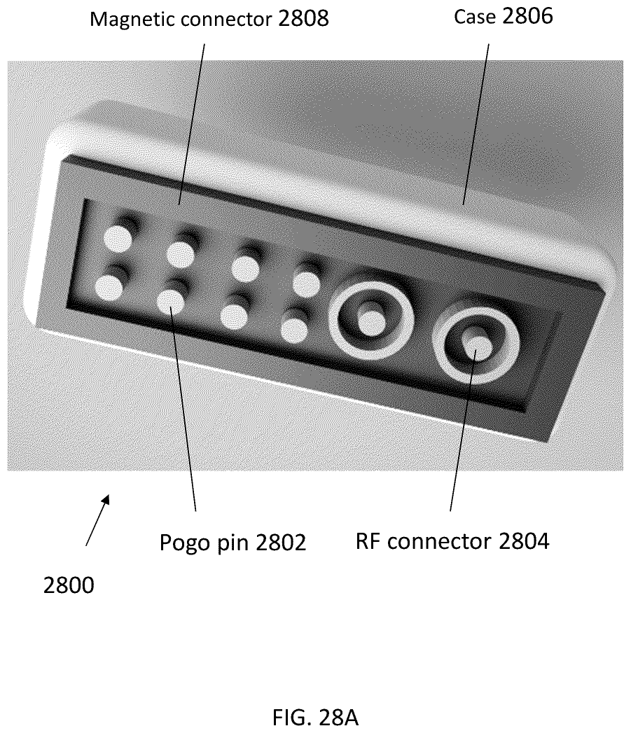

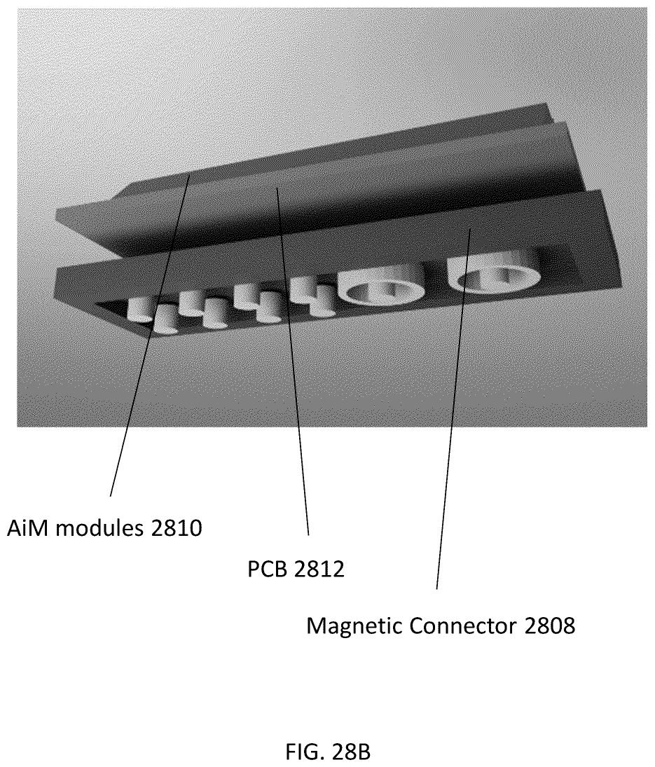

Turning to the pin arrangement of the dongle, FIG. 28A illustrates a view of a connector in accordance with some embodiments. FIG. 28B illustrates another view of the connector of FIG. 28A in accordance with some embodiments. As shown in FIGS. 28A and 28B, the dongle 2800 may be a pogo pin-based interconnect that includes pogo pins 2802 for the AiM module power supply, reference signals, power enable, and IF signals with ground shielded mechanisms for the mmwave IF interface. The pogo pins 2802 and RF connectors 2804 may extend from and be retained within a magnetic connector 2808 that is housed within a case 2806. The case 2806 may also contain the AiM modules 2810 and PCB 2812 that controls the AiM modules 2810. The dongle 2800 may be designed to enable power, digital, and RF signals together on a single connector considering the challenges to provide proper isolation between RF and digital interfaces.

The connector portion of the dongle 2800 of FIGS. 28A and 28B may include 10 pogo pins: 2 pins for Vsys power (to meet a maximum current of 1.2 A), 2 pins for PON signals (1 for each AiM module 2810), 1 pin for Vref power (to meet a maximum current of 90 mA), 2 pins specially designed for RF signals (V, H), and 3 pins for ground.

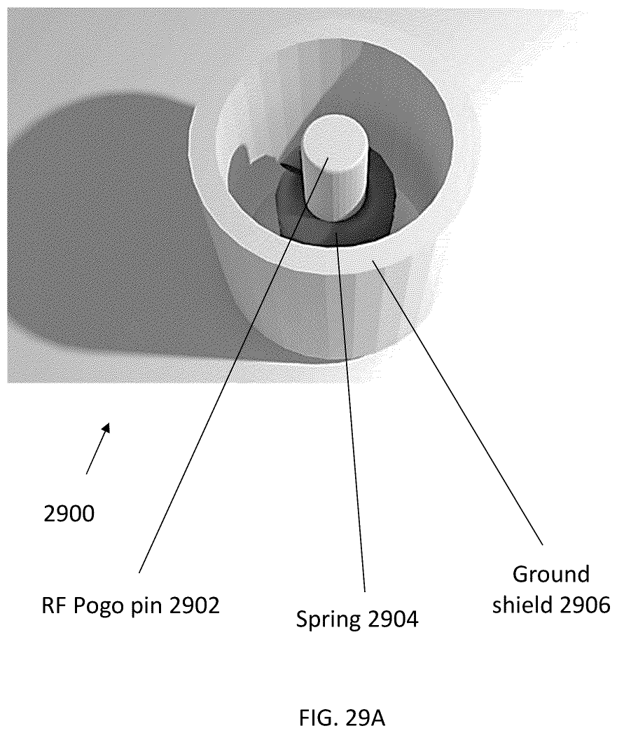

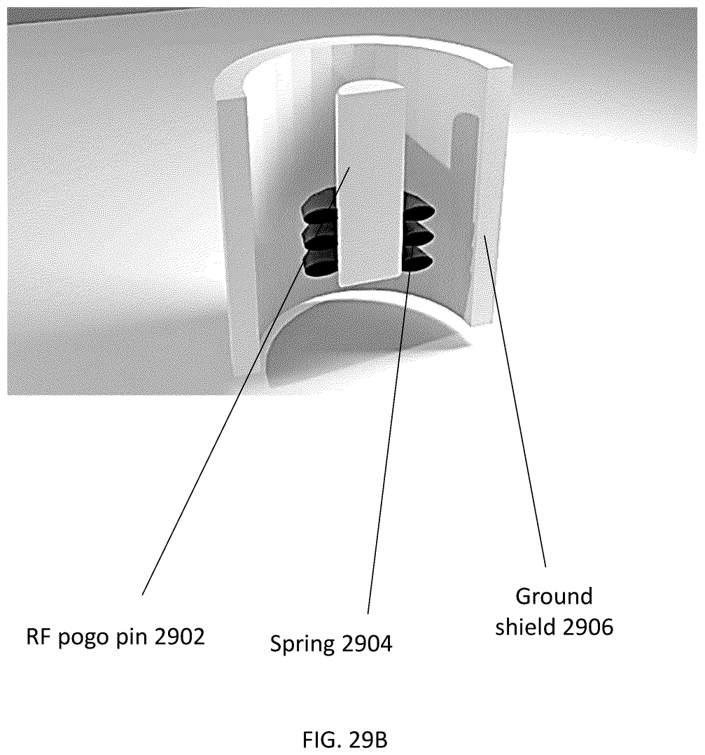

The dongle provides a pogo pin-based interconnect with pins for the AiM module signals and specially designed pins for the RF connectors. FIG. 29A illustrates a top view of a RF connector in accordance with some embodiments. FIG. 29B illustrates a cutaway view of the RF connector of FIG. 29A in accordance with some embodiments. The RF connector 2900 includes an RF pogo pin 2902 to provide the RF signals, a spring 2904 to permit the RF pogo pin 2902 to make contact with the appropriate connector on the laptop, and a cylindrical RF ground shield 2906 surrounding the spring 2904 and the RF pogo pin 2902. The ground shield 2906 is configured to meet the 50-ohm impedance requirement and provide proper isolation for high frequency mmWave RF signals. In some embodiments, the pogo pin covers may be formed from polyimide or rubber.

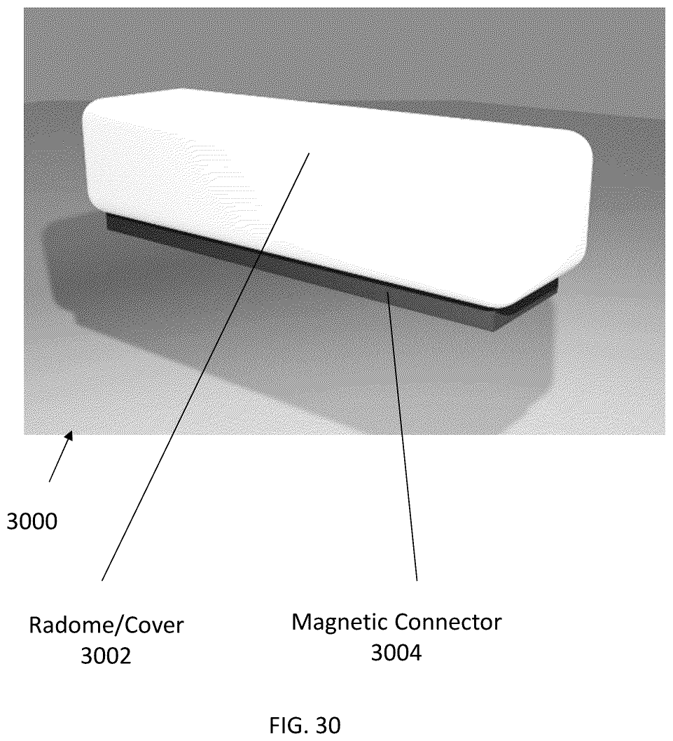

FIG. 30 illustrates an antenna module dongle in accordance with some embodiments. The perspective view of the dongle 3000 shown in FIG. 30, illustrates the various pins, connectors, and electronics are contained in the case 3002 (also referred to as a radome), which is connected with the laptop via a magnetic connector 3004. The laptop may have a recess in which the dongle 3000 fits and that may be able to be uncovered to expose the associated connectors for connection to the dongle 3000. In other embodiments, the laptop may not have a recess. The magnetic connector 3004 may fix the dongle 3000 in place on the laptop, whether or not the laptop contains such a recess.

FPC Based Modular mmWave AiM Module Holder as EMI Shield and Thermal Spreader

In some embodiments, multiple AiM modules may be disposed in the base of a laptop. However, the introduction of multiple AiM modules in the base may result in the AiM modules being proximate to system noise sources such as memory integrated circuits (ICs), system on a chip (SOC), and various types of interconnects. This may result in RF interference (RFI) issues due to coupling of the system noise to the mmWave antenna. As the mmWave frequency band ranges from 26 to 40 GHz: it may be difficult to design a metal shield that works for the given frequencies. Reducing the dependency of RF protection on metal shields, which may have an airgap or cutout of less than 0.75 mm to minimize the electromagnetic leakage, may be difficult. Designing PCB to achieve shields without such a gap may be difficult due to PCB inner layer breakout routing—in particular routing requirements establish a relaxed shield via to via pitch gets up to 5 mm, which may result in to mmWave frequency leakage, causing RFI issues. To overcome this, an antenna barricade may be used for the mmWave AiM module with the help of an IF channel FPC and metal fence to reduce the dependency of RF protection on metal shields.

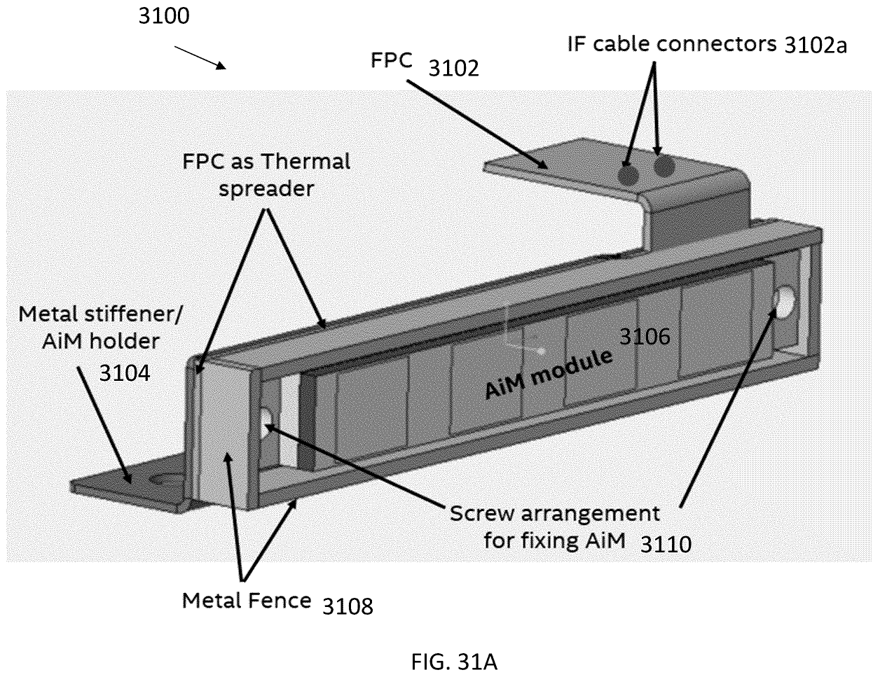

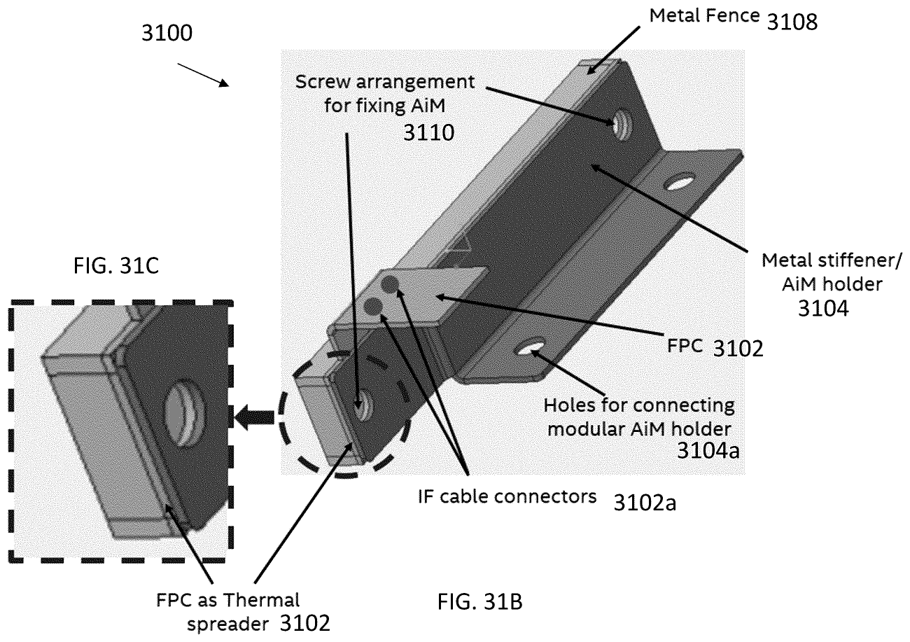

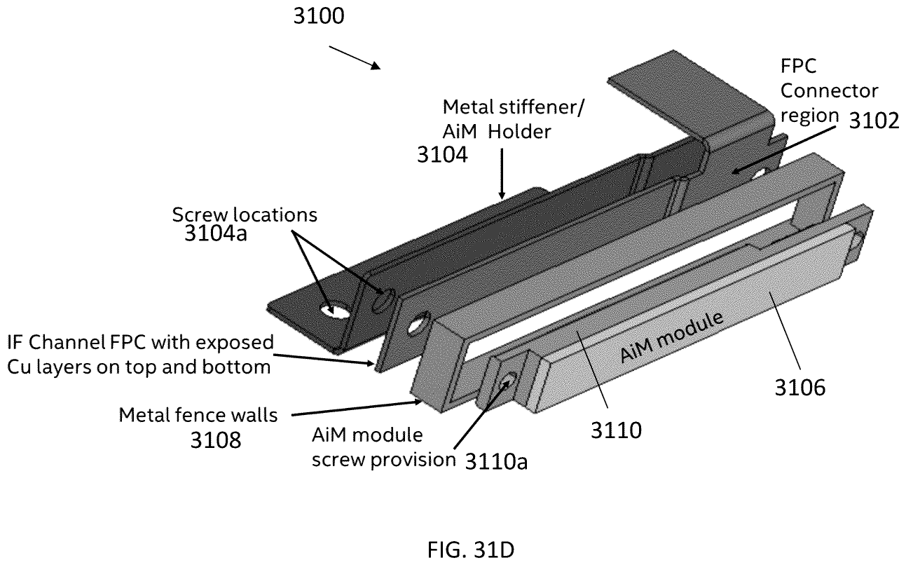

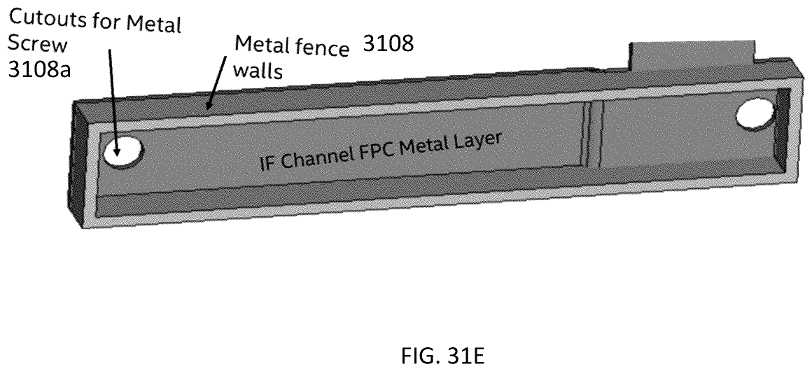

FIG. 31A illustrates a front view of an AiM module in accordance with some embodiments. FIG. 31B illustrates a back view of the AiM module of FIG. 31A in accordance with some embodiments. FIG. 31C illustrates a portion of the back view of FIG. 31B in accordance with some embodiments. FIG. 31D illustrates an exploded view of the AiM module of FIG. 31A in accordance with some embodiments. FIG. 31E illustrates an electromagnetic interference (EMI) shield assembly in accordance with some embodiments. In the AiM module system 3100 shown in FIGS. 31A-31E, an FPC 3102 may be used as a thermal spreader (as best seen in FIG. 31C) and EMI shield for the AiM module 3106 in conjunction with a metal stiffener 3104 and metal fence 3108. The metal fence 3108 may be attached to a top of the FPC 3102 with a conductive glue or solder to provide the EMI shielding. The metal fence 3108 may completely encircle the AiM module 3106, have a shape (as shown, rectangular) that corresponds to that of the AiM module 3106, and have cutouts 3108a for the screws. The FPC 3102 may include IF cable connectors 3102a to couple signals to the AiM module 3106.

As the AiM module system 3100 is modular, the AiM module system 3100 can be used for T/L systems, and the AiM module 3106 may be placed near locations with improved RFI with shielding in addition to reducing the length of the FPC 3102 with low IR losses.

The modular shield box formed from the FPC 3102, metal stiffener 3104, and metal fence 3108 may have limited impact to the radiation characteristics of the AiM module 3106 as the AiM module 3106 may retain the same coverage as a free space AiM module. In addition, the metal fence 3108 may not be grounded, which may help to retain the antenna array performance and can also be used for plastic systems. The metal fence 3108, as shown e.g., in FIG. 31E, may provide a barricade wall between the mmWave antennas of the AiM module 3106 and system noise sources.

The AiM module 3106 may be attached to the FPC 3102 and/or metal fence 3108 through screws (or other fasteners) in a screw arrangement 3110a at opposing edges of a base 3110 on which the AiM module 3106 is disposed. This provides a simple, detachable and low cost solution for the modular shield box while mitigating vibrations. The portions of the modular shield box may be formed from one or more thermally conductive materials to achieve good thermal performance.

The metal stiffener 3104 may be formed in a substantially L shape from aluminum or another conductive material that is sufficiently inflexible to support the connected structure (FPC 3102 and AiM module 3106) without bending. The metal stiffener 3104 may have holes 3104a formed in or near the corners to connect the metal stiffener 3104 to the FPC 3102 and AiM module 3106 and to fix the metal stiffener 3104 to the laptop chassis.

The IF channel FPC 3102 may be extended beyond the AiM module connector region shown in FIG. 31D along the length of the AiM module 3106. The FPC 3102 may have an exposed Cu layer. The metal fence 3108, metal stiffener 3104, and FPC 3102 Cu layers may be electrically connected to each other. Conductive glue may be used to connect the parts together. The FPC 3102 ground and metal fence 3108 may form an enclosure equivalent to a single piece shield, thereby providing EMI shielding. The FPC 3102 metal layers, metal stiffener 3104, and metal fence 3108 walls combined together help as heat spreader for heat dissipation of the AiM module 3106.

### Antenna Identification System

Another aspect of modular electronic device systems is the ability to upgrade components of the electronic device for sustainability. Modularization of the radio components (including various modems) and antennas in a laptop may be desirable. In particular, with the advance of new technologies, mobile devices like laptops and mobile phones are updated with each change in technology. Such updates may call for re-designing and certifying the system even for small updates.

Antennas are passive in nature and do not have an electronic identity. Thus, no closed loop mechanism exists to ensure radio-to-antenna compatibility. This creates complexities in certification aspects (such as federal communication commission (FCC) requirements) when updates are performed at the user end. It is thus desirable to provide a mechanism that ensures RF path equivalency of a user-upgraded system to an OEM certified system. In addition, issues associated with RF cabling and connector-related failures may lead to modem failures/non-usability. This may create a related discontinuity of user experience as such failures may not be identifiable by the system as no feedback may occur from antenna to the modem.

To better enable user end modification, an inherent feedback system may be employed to ensure certification compliance from wireless modem to antenna characteristics. This enables only the modem being replaced without changing the full system when there is an upgrade in the modem. To ensure the FCCID/ETSI certification is not violated, it is desirable to provide feedback between the modem and the antenna to ensure the equivalency between modem to antenna and to make sure the antenna is not changed as against delta certified upgrade options.

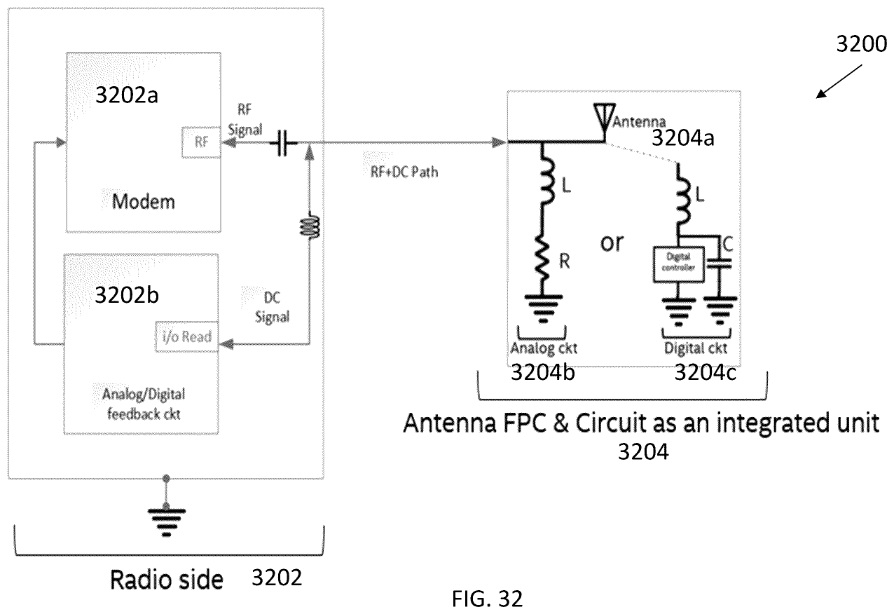

FIG. 32 illustrates circuitry in accordance with some embodiments. The electronic device 3200 shown in FIG. 32 may include a radio side 3202 and an antenna side 3204. The radio side 3202 may include one or more wireless modems 3202a and a feedback circuit 3202b. The antenna side 3204 may include one or more antennas 3204a, and an analog circuit 3204b and/or a digital circuit 3204c. In the electronic device 3200, a DC and/or low frequency path (overriding and decoupled) through RF lines (RF feed and corresponding cable ground) may be used to interconnect the radio side 3202 and the antenna side 3204. The analog circuit 3204b and/or a digital circuit 3204c may provide unique characteristics, either a unique impedance (of analog circuit 3204b) or a digital identifier (digital circuit 3204c).

The feedback circuit 3202b at the radio side 3202 or radio host board end may be used to uniquely identify the antenna 3204a by the digital or analog characteristics presented at the antenna side 3204 over the above-mentioned DC path (digital communication or unique impedance). This unique identity may ensure that the antenna 3204a is identified and compatible with the radio side 3202 and specifically the modem 3202a.

The feedback circuit 3202b may verify the analog circuit 3204b and/or digital circuit 3204c at each power up (or based on manual activation). The RF path may only be enabled after this verification succeeds. The verification may not only enable antenna identification but also enable detection of open antenna situations (i.e., when a problem has occurred in the connection between the antenna side 3204 and the radio side 3202). Note that while this is directed to a mobile electronic device such as a laptop, similar circuitry may be employed in wireless base station antennas.

In addition, RF output power from the modem 3202a along with the overridden low frequency or DC path may be provided to the antenna 3204a and the analog circuit 3204b or digital circuit 3204c. If the RF path is DC decoupled, this may not impact the overridden DC or low frequency signal. The DC/low frequency path may be AC decoupled and hence the transmitted RF energy may not affect the analog circuit 3204b or digital circuit 3204c.

As one operation before enabling the RF path of the modem 3202a, the unique identity (impedance of the analog circuit 3204b and digital ID of digital circuit 3204c) may be determined by the feedback circuit 3202b. The feedback circuit 3202b may determine whether the antenna 3204a is compatible with the modem 3202a. The feedback circuit 3202b may enable the RF path may be subject to a correct identity being determined, and may disable the RF path if no identity or a non-valid identity is determined. If the feedback circuit 3202b determines that there is no antenna connected, or a different identity antenna is connected than an intended antenna, feedback may be transmitted to the radio as an antenna identity mismatch. Based on this feedback the RF transmit path may be disabled and a notification sent to users regarding the identity mismatch or lack of antenna being present (with different notifications being sent dependent on the circumstances detected).

As shown, the modem 3202a may be coupled to the signal path via an AC coupler (e.g., a capacitor), while the feedback circuit 3202b may be coupled to the signal path via a DC coupler (e.g., an inductor). In other embodiments, other circuits may be used to isolate the appropriate signals to limit the modem 3202a to receive/transmit only the RF signals, and the feedback circuit 3202b to receive only the DC signals.

### Improved Isolation for Adjacent Slot Antennas

Lighter, thinner and bezel-less system design is desired for electronic devices, notably laptops. In particular, many embodiments of laptops use a full metal chassis system with all six (or more) antennas on the laptop base. Antenna placement is challenging to design in such a system: antennas that are placed close to each other may yield poor isolation causing a drop in wireless throughput. In particular, the implementation of PCB antennas on the base of a laptop may use large plastic cut-outs in both the C-cover and D-cover. However, large metal cutouts are not acceptable from an industrial design perspective because of compromising the otherwise seamless design and making the system weaker.

To mitigate these issues, a united two slot antenna system may be provided in the metal chassis of the laptop with better isolation for a combination 5G/LTE/MIMO/WIFI-6E antenna design without any physical spacing. While generally antenna performance (impedance matching and radiation efficiency) deteriorates if antenna comes close to metal, the antenna architecture may operate with a minimum keep out zone (KOZ) from metal components in the system without compromising the mechanical structural performance. The antenna placement on the laptop base allows design of bezel-less or narrow bezel LID/display. The chassis design may have minimum plastic/non-conductive material in a metal chassis.

The slot antenna system in a laptop may include combined horizontal slots and/or combined vertical slots. For combined horizontal slots, shunt resistor-capacitor discrete components between a slot antenna at the C-cover side and metal shorting at the D-cover side may be used. The shunt capacitor-resistor (CR) circuit may improve the isolation for a specific frequency band. For combined vertical slots, a half-wavelength shorting stub may be used along with two slot antennas. The half-wavelength shorting stub may help to cancel the current phase coupling between the two antennas and thereby improve isolation. As shown, a total horizontal length of the slots may be a half-wavelength.

Various methods may be used to unite or merge two slot antennas while maintaining performance (efficiency, isolation) with no spacing, which also may improve miniaturization. The isolation is achieved by current and EM field cancellation between ports.

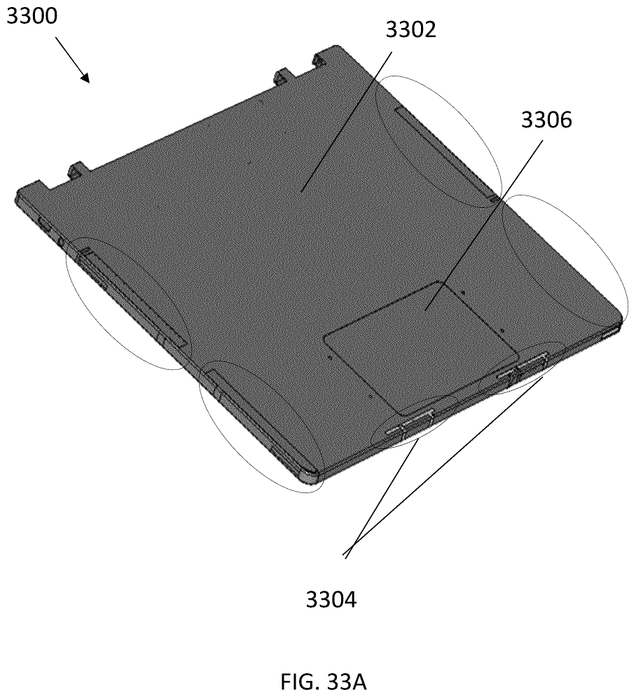

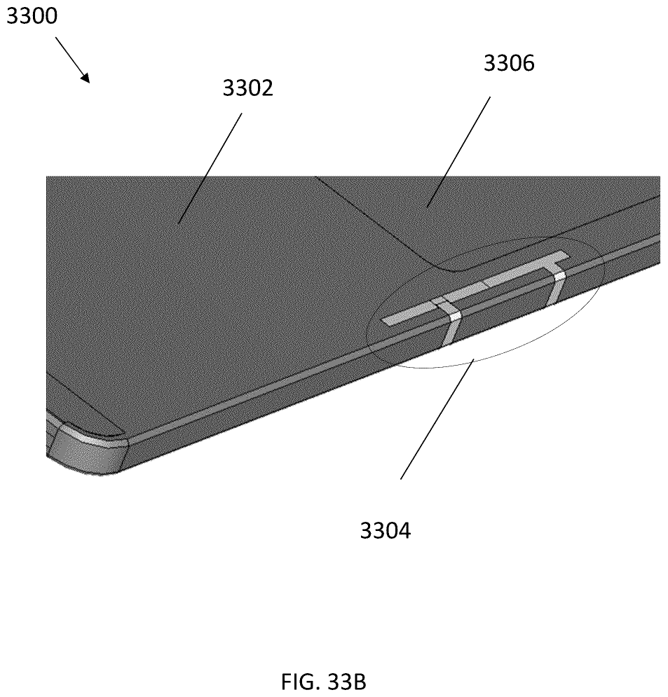

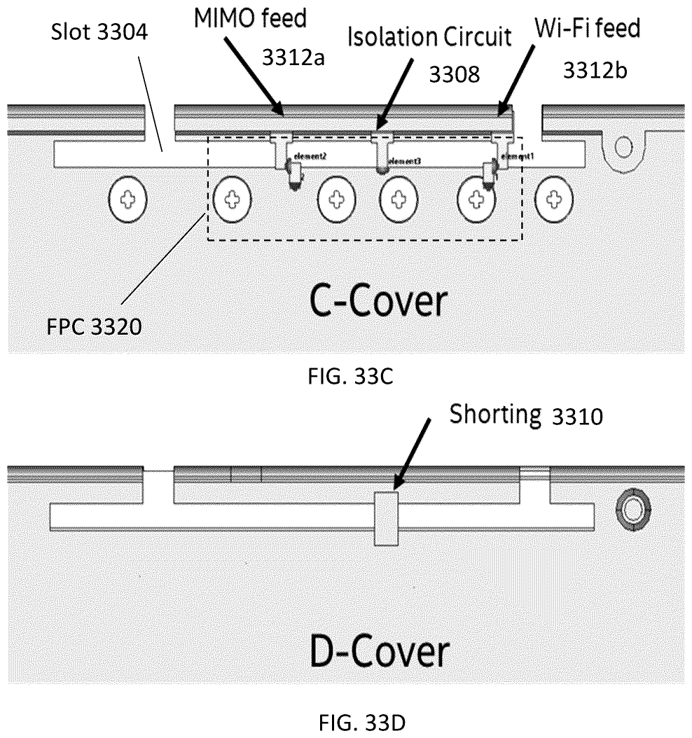

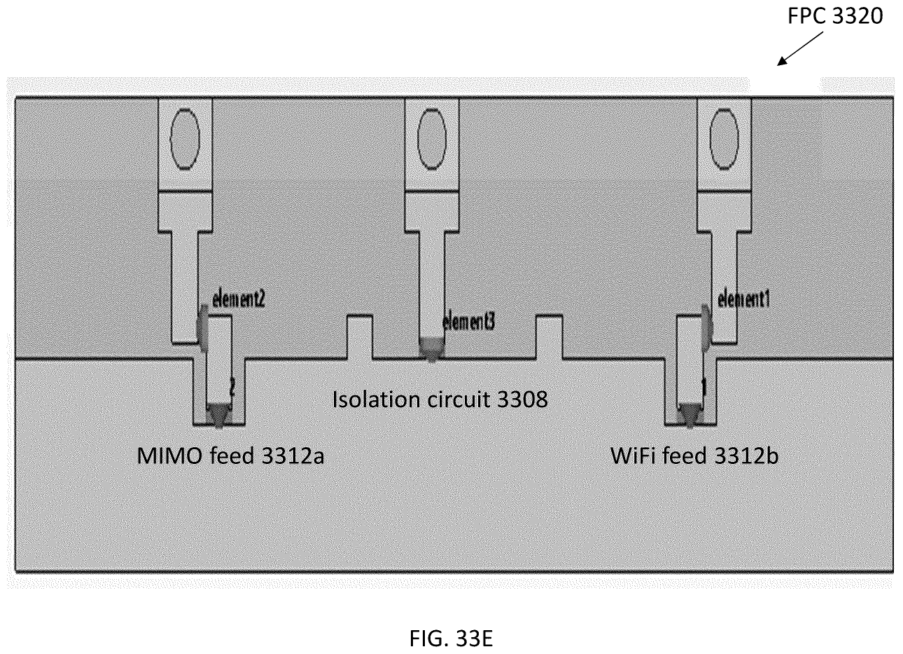

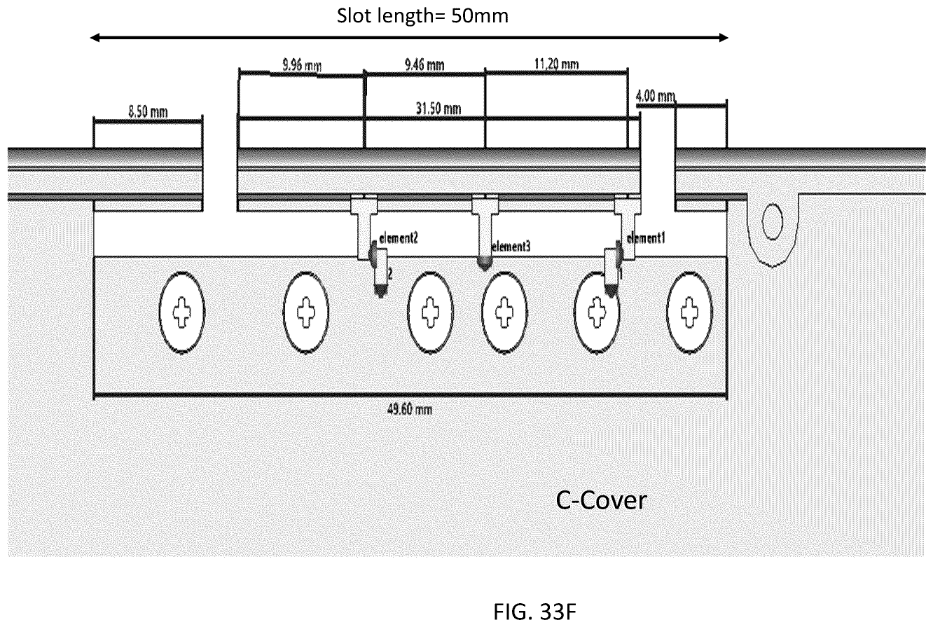

FIG. 33A illustrates a perspective view of a C-cover containing merging horizontal slots in accordance with some embodiments. FIG. 33B illustrates an enlarged portion of the C-cover of FIG. 33A in accordance with some embodiments. FIG. 33C illustrates a side view of the C-cover of FIG. 33A in accordance with some embodiments. FIG. 33D illustrates a side view of a D-cover associated with the C-cover of FIG. 33A in accordance with some embodiments. FIG. 33E illustrates an enlarged view of an FPC shown in FIG. 33C in accordance with some embodiments. FIG. 33F illustrates another view of the side view of the C-cover of FIG. 33A in accordance with some embodiments.

FIGS. 33A-33F illustrate the C-cover 3302 of a laptop 3300 in which a slot antenna 3304 having horizontal slots are disposed. The horizontal slots of the slot antenna 3304 are combined. Horizontal slots of the slot antenna 3304 may be disposed in one or more locations indicated by the ovals in FIG. 33A, such as on opposing sides of the touchpad area 3306 as shown in more detail in FIG. 33B. To improve isolation shunt resistor-capacitor discrete components 3308 may be added in C-cover side of the laptop and a conductive (metal) shorting 3310 may be added in the D-cover side between the slot antennas as shown in FIGS. 33C and 33D. The resistor/capacitor isolation circuit 3308 in the MIMO and Wi-Fi feed traces (at the C-cover) 3312a, 3312b of a FPC 3320 may improve isolation (decoupling) by about 5 to about 10 dB and conductive shorting in D-cover by about 2 to about 5 dB, as shown in FIG. 33E. The total length of slot antenna 3304 may be about 50 mm with no gap (i.e., the slot antennas are continuous) between the sections of the slot antenna 3304, as shown in FIG. 33F.

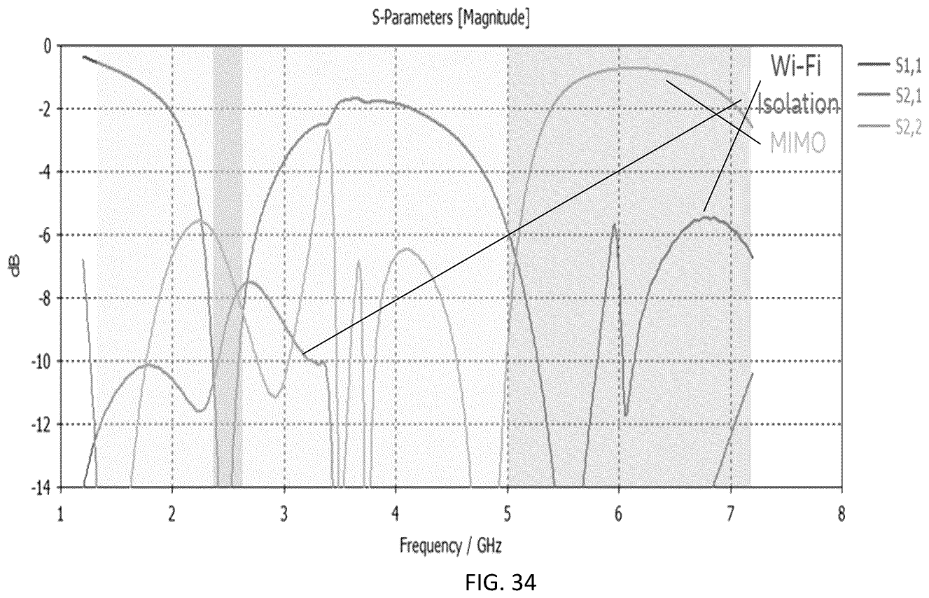

FIG. 34 illustrates S-parameter results of combined horizontal slot in accordance with some embodiments. In the simulation, port-01 of the slot antenna is tuned for the Wi-Fi-6E frequency bands (2.4-2.5 GHZ and 5.15-7.125 GHz) and port-02 is tuned for the 5G MIMO frequency band (1.8-2.7 GHZ and 3.3-5.0 GHZ). As seen in FIG. 34, both slot antennas have a good return loss for the respective operating bands and have good impedance matching with 50Ω. The S21 parameter is the isolation between antenna-1 (Wi-Fi) and antenna-2 (5G MIMO). The achieved return loss or impedance bandwidth meets 5G MIMO and Wi-Fi6E antenna design requirements.

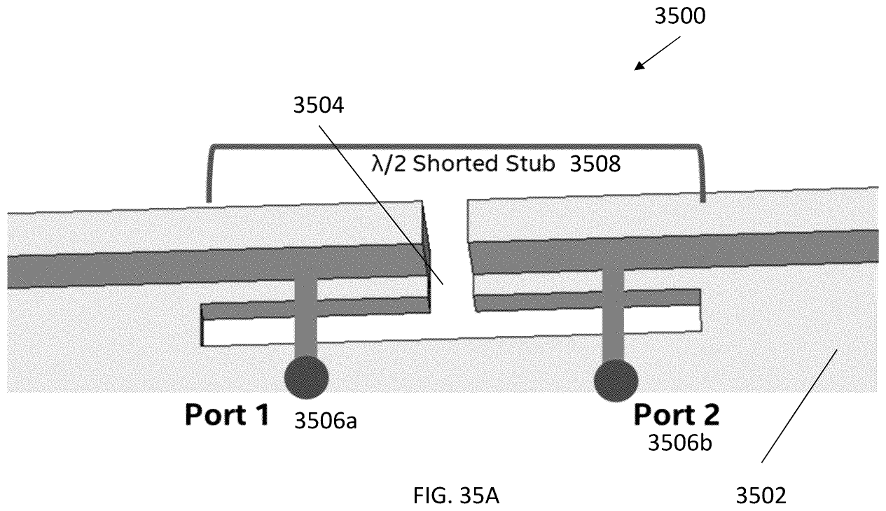

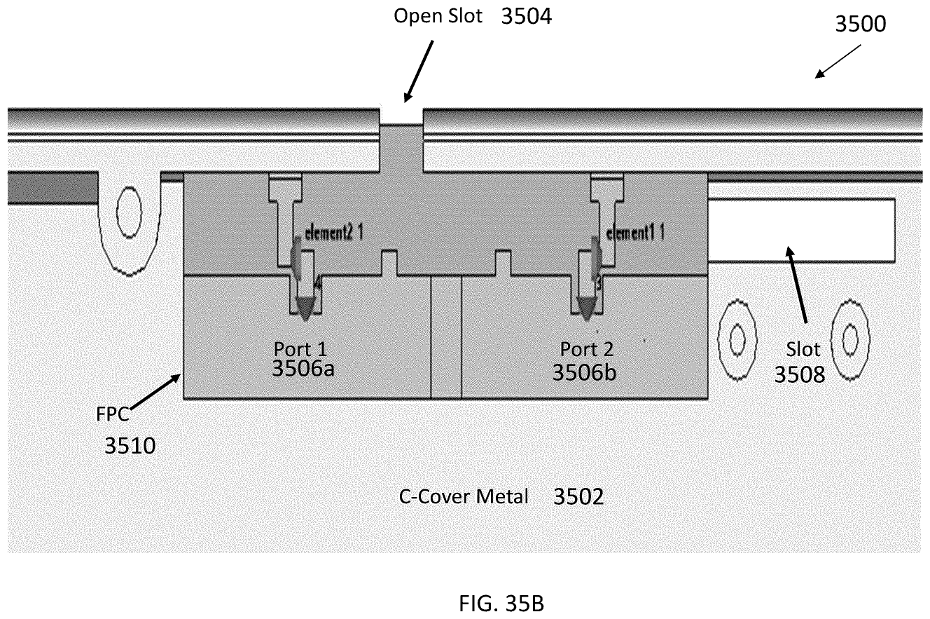

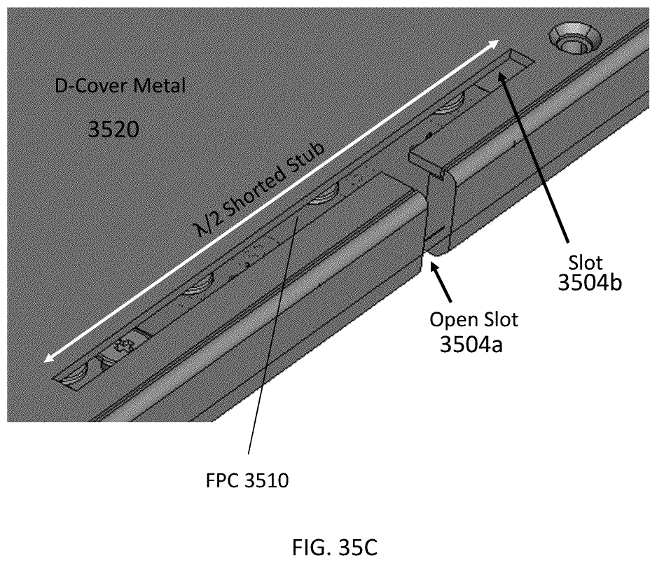

FIG. 35A illustrates merging vertical slots in accordance with some embodiments. FIG. 35B illustrates C-cover metal containing the merging vertical slots of FIG. 35A in accordance with some embodiments. FIG. 35C illustrates D-cover metal containing the merging vertical slots of FIG. 35A in accordance with some embodiments. The C-cover 3502 of a laptop 3500 may contain a vertical slot 3504. The vertical slot 3504 may be common for both antennas fed by ports 3506a, 3506b and a half-wavelength shorting stub 3508 may be covered by both antennas as shown in FIG. 35A. The half-wavelength shorting stub 3508 may help to cancel the current phase coupling between the two antennas and improve isolation. The antenna structure may thus include an open slot 3504 (vertical slot 3504) and half-wavelength shorting stub 3508 as shown in FIG. 35B, and may be present in both the C-cover 3502 (shown in FIGS. 35A and 35B), as well as the D-cover 3520 shown in FIG. 35C. The ports 3506a, 3506b may be connected to an FPC 3510 as shown in FIGS. 35B and 35C.

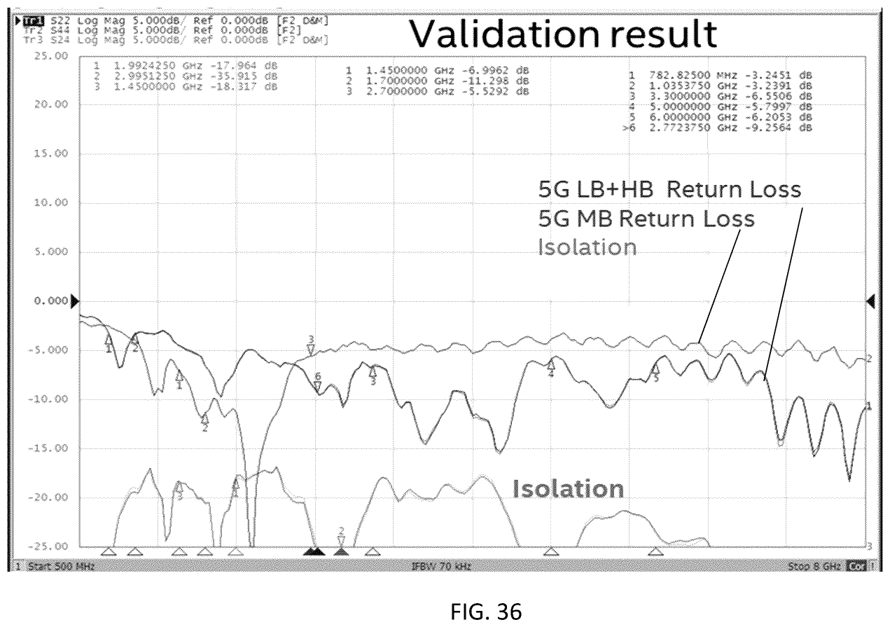

FIG. 36 illustrates S-parameter results of combined vertical slots with a half wavelength stub in accordance with some embodiments. While a dual feed 5G sub 6 GHz slot antenna may face isolation failure between both ports in a tablet design, the antenna slot of FIG. 35 may improve the isolation for the dual feed 5G antenna. The half wavelength stub may be created from the back metal frame of the display and connected with the combined vertical slots antennas.

### Speaker Integrated Antenna

Antenna location in various electronic devices is of import as proximity to a human or a foreign object (e.g., <10 mm) may cause the antenna to become detuned and impact the overall wireless performance. The Specific Absorption Rate (SAR) may increase with decreasing human proximity to the antenna radiating elements. Previous locations of antenna components in laptops include antenna FPCs attached to or printed on a dielectric platform at the C-cover or D-cover of the laptop chassis. This, however, may result in a larger RF window opening on the opposite side of the FPC to enable the desired EM radiation characteristics.

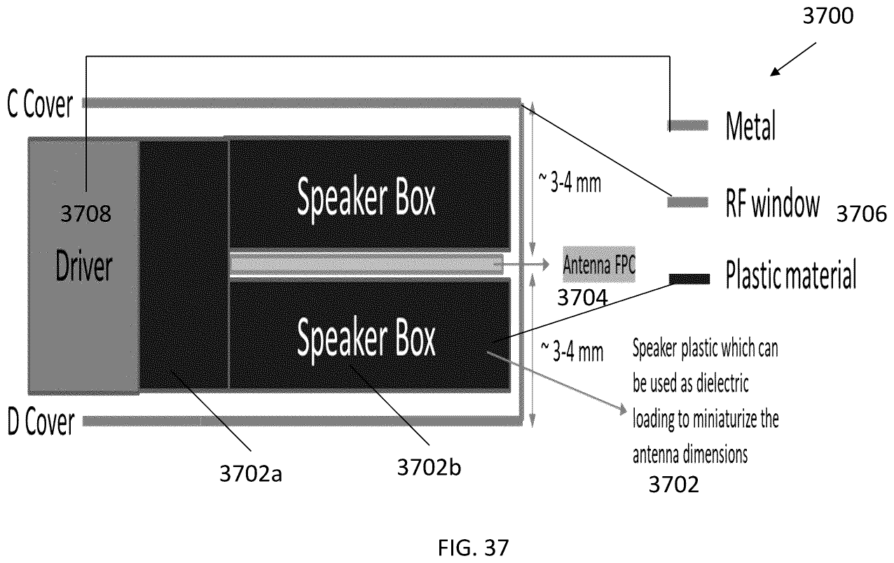

In some embodiments, antenna design in a laptop may locate the antenna FPC near the speaker box (cavity) of a speaker to avoid being detuned. FIG. 37 illustrates a split speaker-integrated antenna in accordance with some embodiments. In the arrangement 3700 shown in FIG. 37, the cavity that forms the speaker box 3702 is split into two speaker box portions 3702b that are connected by a common speaker box area 3702a (thus only a portion of the speaker box 3702 may be split into the speaker box portions 3702b). The antenna FPC 3704 disposed in the area between speaker box portions 3702b. The speaker box 3702 may be formed from a non-conductive material such as plastic. The arrangement 3700 forms a sandwich structure that retains the audio performance of the speaker, does not impact the overall speaker back volume, uses the speaker plastic as dielectric loading to miniaturize the antenna dimensions, and is able to avoid the antenna FPC adhesive in forming the arrangement 3700 while distancing the antenna FPC 3704 from the speaker driver 3708 that may otherwise cause interference. The distance between the antenna FPC 3704 and the RF window 3706 formed by the C-cover and the D-cover is about 3 mm to about 4 mm. Although the split of the speaker box 3702 is shown as being equal, in other embodiments it may be unequal.

The splitting of the speaker box 3702 may also avoid the human proximity issues that may otherwise result if the speaker box 3702 was not split and the antenna FPC 3704 attached to one surface of the speaker box 3702, which may result in the antenna FPC 3704 being close to the surface of the C-cover or D-cover and thus reduce the SAR due to the above proximity issues. That is, the placement of the antenna FPC 3704 between the speaker box 3702 portions may increase the distance from human proximity and thus increase SAR.

### EXAMPLES

Example 1 is an electronic device comprising: a first section and a second section connected by a hinge assembly: and a mmWave antenna integrated module (AiM) module disposed in the hinge assembly.

In Example 2, the subject matter of Example 1 includes, wherein the electronic device is a laptop, the first section contains a display and the second section is a base of the laptop.

In Example 3, the subject matter of Examples 1-2 includes, wherein the AiM module is stationary within the hinge assembly.

In Example 4, the subject matter of Examples 1-3 includes, wherein the hinge assembly comprises: a rotational hinge portion attached to the first section and including a cylindrical portion, configured to rotate with rotation of the first section, a hinge mandrel attached to the second section, and a static hinge portion attached to the hinge mandrel and to which the AiM module is attached, the static hinge portion configured to pass through the cylindrical portion of the rotational hinge portion and remain stationary with rotation of the first section.

In Example 5, the subject matter of Example 4 includes, wherein the static hinge portion is modular and contains a first section attached to the hinge mandrel and a second section to which the AiM module is attached, the first section detachable from the second section.

In Example 6, the subject matter of Examples 4-5 includes, wherein the hinge assembly further comprises cable clamps that clamp to the static hinge portion, the cable clamps configured to retain cables directly coupled to the AiM module such that the cables remain stationary with rotation of the first section.

In Example 7, the subject matter of Example 6 includes, wherein: the cables extend parallel and adjacent to the rotational hinge portion, and the rotational hinge portion, the static hinge portion, the AiM module, and the cables are retained within a case.

Example 8 is an electronic device comprising: a first section and a second section connected by a hinge assembly: and a mmWave antenna integrated module (AiM) module at least one of magnetically or rotationally coupled to one of the first section or the second section.

In Example 9, the subject matter of Example 8 includes, wherein: the AiM module is rotationally coupled to one of the first section or the second section, and the AiM module is rotated in response to detection by the electronic device that a mmWave transmission is unable to be received from a base station that is in communication with the electronic device.

In Example 10, the subject matter of Example 9 includes, wherein the electronic device is configured to, in response to detection by the electronic device that the mmWave transmission is unable to be received from the base station: request, from the base station, base station coordinates, receive, from the base station in response to the request, the base station coordinates, determine a location and orientation of the electronic device, determine, based on the base station coordinates and location and orientation of the electronic device, an angle of rotation of the AiM module, and rotate the AiM module based on the angle of rotation.

In Example 11, the subject matter of Example 10 includes, wherein: after rotation of the AiM module based on the angle of rotation, determine that the mmWave transmission is able to be received from the base station, and in response to a determination that the mmWave transmission is able to be received from the base station, use beam steering to detect a change in at least one of the location or orientation of the electronic device and adjust the angle of rotation in response to detection of the change.

In Example 12, the subject matter of Examples 8-11 includes, wherein: the AiM module is magnetically coupled to one of the first section or the second section via a magnetic conductor, and a dongle contains a plurality of AiM modules disposed at an angle to each other, a printed circuit board (PCB) on which the AiM modules are disposed and to which the AiM modules are electrically connected via a flexible printed circuit (FPC), the magnetic conductor on which the PCB is disposed, and a case configured to retain the AiM modules, the PCB, and the magnetic conductor.

In Example 13, the subject matter of Example 12 includes, wherein the AiM modules are driven via a single intermediate frequency (IF) interface through a Double Pole Double Throw (DPDT) switch that is configured to switch the IF interface to one of the AIMs based on Power On (PON) signals of the AiM modules, the DPDT switch configured to turn on and connect to one of the AiM modules and enable the IF interface, power and reference signals for the one of the AiM modules.

In Example 14, the subject matter of Example 13 includes, wherein the dongle further contains pogo pins and radio frequency (RF) connectors, the pogo pins configured to supply power, reference signals, power enable, and IF signals to the AiM modules from the electronic device, the RF connectors including RF pogo pins each surrounded by a ground shield.

In Example 15, the subject matter of Examples 12-14 includes, °.

Example 16 is an electronic device comprising: a first section and a second section connected by a hinge assembly: and a shielded mmWave antenna integrated module (AiM) module coupled to one of the first section or the second section.

In Example 17, the subject matter of Example 16 includes, wherein: the AiM module is encircled by a substantially rectangular metal fence configured to provide radio frequency (RF) shielding for the AiM module, the AiM module is disposed on and electrically connected to a flexible printed circuit (FPC) on which the metal fence is disposed, the FPC is disposed on a metal stiffener to which the AiM module and FPC are attached, and the metal stiffener, the FPC, and the metal fence configured to spread heat of the AiM module.

In Example 18, the subject matter of Examples 16-17 includes, wherein: an antenna module contains the AiM module and one of an analog circuit or a digital circuit configured to provide an identifier, the identifier being a unique impedance for the analog circuit and a digital identification for the digital circuit, and the electronic device comprises: a modem coupled to a signal path via an alternating current (AC) coupler and configured to communicate radio frequency (RF) signals with the antenna module via the signal path, and a feedback circuit coupled to the signal path via a direct current (DC) coupler and configured to receive the identifier via the signal path.

In Example 19, the subject matter of Example 18 includes, wherein: the feedback circuit is configured to detect the identifier, and in response to no identifier being detected or a non-valid identifier being detected, the electronic device is configured to disable the signal path such that the modem is unable communicate the RF signals with the antenna module.

In Example 20, the subject matter of Example 19 includes, wherein in response to no identifier being detected or a non-valid identifier being detected, the electronic device is further configured to provide a user notification that depends on which of no identifier is detected and the non-valid identifier is detected.

In Example 21, the subject matter of Examples 16-20 includes, wherein: the electronic device is a laptop, the laptop comprises a C-cover and a D-cover that contain merged horizontal slot antennas in a metal portion of a chassis, the C-cover containing C-portions of the merged horizontal slot antennas and the D-cover containing D-portions of the merged horizontal slot antennas, the merged horizontal slot antennas are continuous and lack a gap therebetween, and resistor-capacitor discrete components are disposed in the C-portions, and metal shorting is disposed between the D-portions.

In Example 22, the subject matter of Examples 16-21 includes, wherein: the electronic device is a laptop, the laptop comprises merged vertical slot antennas in a metal portion of a chassis, the merged vertical slot antennas are continuous and lack a gap therebetween, and a total horizontal length of the merged vertical slot antennas forms a half wavelength shorting stub.

In Example 23, the subject matter of Examples 16-22 includes, wherein: the electronic device comprises a cavity that forms a speaker box, the speaker box comprises a common speaker box area and vertically-adjacent speaker box portions that each extend laterally from the common speaker box area, and a flexible printed circuit (FPC) electrically connected to the AiM module is disposed between the vertically-adjacent speaker box portions.

In Example 24, the subject matter of Example 23 includes, wherein: the electronic device is a laptop, the laptop comprises a C-cover and a D-cover between which the speaker box is disposed, a driver that is configured to provide sound for the speaker box is adjacent to the common speaker box area, and the speaker box is formed from plastic.

Example 25 is at least one machine-readable medium including instructions that, when executed by processing circuitry, cause the processing circuitry to perform operations to implement of any of Examples 1-24.

Example 26 is an apparatus comprising means to implement of any of Examples 1-24.

Example 27 is a system to implement of any of Examples 1-24.

Example 28 is a method to implement of any of Examples 1-24.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An electronic device comprising:
a first section and a second section connected by a hinge assembly; and
a mmWave antenna integrated module (AiM) module disposed in the hinge assembly.

2. The electronic device of claim 1, wherein the electronic device is a laptop, the first section contains a display and the second section is a base of the laptop.

3. The electronic device of claim 1, wherein the AiM module is stationary within the hinge assembly.

4. The electronic device of claim 1, wherein the hinge assembly comprises:
a rotational hinge portion attached to the first section and including a cylindrical portion, configured to rotate with rotation of the first section,
a hinge mandrel attached to the second section, and
a static hinge portion attached to the hinge mandrel and to which the AiM module is attached, the static hinge portion configured to pass through the cylindrical portion of the rotational hinge portion and remain stationary with rotation of the first section.

5. The electronic device of claim 4, wherein the static hinge portion is modular and contains a first section attached to the hinge mandrel and a second section to which the AiM module is attached, the first section detachable from the second section.

6. The electronic device of claim 4, wherein the hinge assembly further comprises cable clamps that clamp to the static hinge portion, the cable clamps configured to retain cables directly coupled to the AiM module such that the cables remain stationary with rotation of the first section.

7. The electronic device of claim 6, wherein:
the cables extend parallel and adjacent to the rotational hinge portion, and
the rotational hinge portion, the static hinge portion, the AiM module, and the cables are retained within a case.

8. An electronic device comprising:
a first section and a second section connected by a hinge assembly; and
a mmWave antenna integrated module (AiM) module at least one of magnetically or rotationally coupled to one of the first section or the second section.

9. The electronic device of claim 8, wherein:
the AiM module is rotationally coupled to one of the first section or the second section, and
the AiM module is rotated in response to detection by the electronic device that a mmWave transmission is unable to be received from a base station that is in communication with the electronic device.

10. The electronic device of claim 9, wherein the electronic device is configured to, in response to detection by the electronic device that the mmWave transmission is unable to be received from the base station:
request, from the base station, base station coordinates,
receive, from the base station in response to the request, the base station coordinates,
determine a location and orientation of the electronic device,
determine, based on the base station coordinates and location and orientation of the electronic device, an angle of rotation of the AiM module, and
rotate the AiM module based on the angle of rotation.

11. The electronic device of claim 10, wherein:
after rotation of the AiM module based on the angle of rotation, determine that the mmWave transmission is able to be received from the base station, and
in response to a determination that the mmWave transmission is able to be received from the base station, use beam steering to detect a change in at least one of the location or orientation of the electronic device and adjust the angle of rotation in response to detection of the change.

12. The electronic device of claim 8, wherein:
the AiM module is magnetically coupled to one of the first section or the second section via a magnetic conductor, and
a dongle contains a plurality of AiM modules disposed at an angle to each other, a printed circuit board (PCB) on which the AiM modules are disposed and to which the AiM modules are electrically connected via a flexible printed circuit (FPC), the magnetic conductor on which the PCB is disposed, and a case configured to retain the AiM modules, the PCB, and the magnetic conductor.

13. The electronic device of claim 12, wherein the AiM modules are driven via a single intermediate frequency (IF) interface through a Double Pole Double Throw (DPDT) switch that is configured to switch the IF interface to one of the AIMs based on Power On (PON) signals of the AiM modules, the DPDT switch configured to turn on and connect to one of the AiM modules and enable the IF interface, power and reference signals for the one of the AiM modules.

14. The electronic device of claim 13, wherein the dongle further contains pogo pins and radio frequency (RF) connectors, the pogo pins configured to supply power, reference signals, power enable, and IF signals to the AiM modules from the electronic device, the RF connectors including RF pogo pins each surrounded by a ground shield.

15. The electronic device of claim 12, wherein the AiM modules are arranged to cover an angle of about 200°.

16. An electronic device comprising:
a first section and a second section connected by a hinge assembly; and
a shielded mmWave antenna integrated module (AiM) module coupled to one of the first section or the second section.

17. The electronic device of claim 16, wherein:
the AiM module is encircled by a substantially rectangular metal fence configured to provide radio frequency (RF) shielding for the AiM module,
the AiM module is disposed on and electrically connected to a flexible printed circuit (FPC) on which the metal fence is disposed,
the FPC is disposed on a metal stiffener to which the AiM module and FPC are attached, and
the metal stiffener, the FPC, and the metal fence configured to spread heat of the AiM module.

18. The electronic device of claim 16, wherein:
an antenna module contains the AiM module and one of an analog circuit or a digital circuit configured to provide an identifier, the identifier being a unique impedance for the analog circuit and a digital identification for the digital circuit, and
the electronic device comprises:
a modem coupled to a signal path via an alternating current (AC) coupler and configured to communicate radio frequency (RF) signals with the antenna module via the signal path, and
a feedback circuit coupled to the signal path via a direct current (DC) coupler and configured to receive the identifier via the signal path.

19. The electronic device of claim 18, wherein:
the feedback circuit is configured to detect the identifier, and
in response to no identifier being detected or a non-valid identifier being detected, the electronic device is configured to disable the signal path such that the modem is unable communicate the RF signals with the antenna module.

20. The electronic device of claim 19, wherein in response to no identifier being detected or a non-valid identifier being detected, the electronic device is further configured to provide a user notification that depends on which of no identifier is detected and the non-valid identifier is detected.

21. The electronic device of claim 16, wherein:
the electronic device is a laptop,
the laptop comprises a C-cover and a D-cover that contain merged horizontal slot antennas in a metal portion of a chassis, the C-cover containing C-portions of the merged horizontal slot antennas and the D-cover containing D-portions of the merged horizontal slot antennas,
the merged horizontal slot antennas are continuous and lack a gap therebetween, and
resistor-capacitor discrete components are disposed in the C-portions, and metal shorting is disposed between the D-portions.

22. The electronic device of claim 16, wherein:
the electronic device is a laptop,
the laptop comprises merged vertical slot antennas in a metal portion of a chassis,
the merged vertical slot antennas are continuous and lack a gap therebetween, and
a total horizontal length of the merged vertical slot antennas forms a half wavelength shorting stub.

23. The electronic device of claim 16, wherein:
the electronic device comprises a cavity that forms a speaker box,
the speaker box comprises a common speaker box area and vertically-adjacent speaker box portions that each extend laterally from the common speaker box area, and
a flexible printed circuit (FPC) electrically connected to the AiM module is disposed between the vertically-adjacent speaker box portions.

24. The electronic device of claim 23, wherein:
the electronic device is a laptop,
the laptop comprises a C-cover and a D-cover between which the speaker box is disposed,
a driver that is configured to provide sound for the speaker box is adjacent to the common speaker box area, and
the speaker box is formed from plastic.
